(19) United States
(12) Patent Application Publication
(10) Pub. No.: US 2019/0148754 A1
(43) Pub. Date: May 16, 2019

(54) USE OF IONIC LIQUIDS AS AN ADJUVANT IN ELECTROCHEMISTRY

(71) Applicants: UNIVERSITE DE RENNES 1, RENNES (FR); CENTRE NATIONAL DE LA RECHERCHE SCIENTIFIQUE, PARIS CEDEX 16 (FR)

(72) Inventors: Didier FLONER, SERVON SUR VILAINE (FR); Ludovic PAQUIN, GUIPEL (FR); Solène GUIHENEUF, NOYAL-SUR-VILAINE (FR); Florence GENESTE, CESSON SEVIGNE (FR); Jean-Pierre BAZUREAU, LA CHAPELLE DES FOUGERETZ (FR)

(21) Appl. No.: 16/306,943

(22) PCT Filed: Jun. 8, 2017
(86) PCT No.: PCT/FR2017/051453

§ 371 Date: Dec. 4, 2018

(30) Foreign Application Priority Data
Jun. 10, 2016 (FR) 16/55373

(51) Int. Cl. H01M 8/083; H01M 4/86; H01M 8/18

(52) U.S. Cl. CPC H01M 8/083; H01M 2300/0014; H01M 8/188; H01M 4/8605

(57) ABSTRACT

The present invention relates to the use of ionic liquids as an adjuvant in electrochemistry. Especially, the invention relates to the use of ionic liquids to solubilise in the aqueous phase, or increase the water solubility of, at least one organic molecule.

The invention relates to the use of ionic liquids as an adjuvant in electrochemistry

Especially, the invention relates to the use of ionic liquids to solubilise in the aqueous phase, or increase the water solubility, of at least one organic molecule.

A solution is a mixture of a compound in large quantity and a compound in small quantity. The compound in large quantity is referred to as the solvent, and the compound in small quantity is referred to as the solute. The obtained mixture of solvent and solute constitutes a liquid phase which remains homogeneous on account of existing intermolecular interactions between the solute and the solvent. This phenomenon is defined as dissolution and is limited to a quantity of solute beyond which saturation is attained. At this stage, the solute no longer dissolves and the solution becomes heterogeneous. The excess of solute leads to the formation of a second phase, which generally is of a solid nature, but which can sometimes appear in the form of a liquid immiscible with the initial solution.

To optimise the solubilisation of a molecule, the simplest approach is that based on the polarity of said molecule, characterised by the dipole moment, μ, the unit of which is the Debye (D). Thus, a non-polar organic molecule will be soluble in a solvent that is apolar or has low polarity (μ<1D), such as hexane, cyclohexane, tetrachloromethane, toluene, etc. Conversely, the dissolution of a polar molecule is promoted by a polar solvent (μ>1.5 D), such as water, dimethylsulfoxide (DMSO), acetone, etc.

The low solubility of a molecule in a solvent is a constraint in the case of a chemical synthesis of which the purpose is to obtain a large quantity of desired product. This limit necessarily results in the use of an increased volume of solvent, which quickly becomes unmanageable. This constraint, however, can become insurmountable as soon as it is necessary to dissolve a molecule in a current-conducting solution. In this regard, it is necessary to take into account on the one hand the dissolution of a conductive salt and on the other hand the dissolution of an organic molecule. These solutions, which could be referred to as molecular electrolytic solutions, in particular are directed at syntheses by way of electrochemistry (electrosynthesis) and at processes for electrochemical storage (cells and batteries). Their implementation involves two steps of dissolution, which have proven to be counter-productive to one another.

The first step consists of dissolving an ionic salt (for example: NaCl, Na₂SO₄, KOH, KCl, etc.), the objective of this being to free at least 0.1 mol·L⁻¹ of positive and negative charges so as to assure ionic conductivity. The dissolution of the salt is facilitated by a polar solvent, and the ability to dissociate the charges is measured by the value of the relative permittivity of the solvent: εᵣ. A polar solvent of increased permittivity, such as water (εᵣ=80), easily separates the positive and negative charges. By contrast, a solvent of low permittivity, such as ethanoic acid (εᵣ=6.2) does not separate the charges and preferably forms pairs of ions, which leads to a low ionic conductivity.

The second step consists of dissolving the organic molecules. Unfortunately, the polar solvents having the greatest dissociation capability, such as water, propylene carbonate, or formic acid, due to their characteristics are very poor solvents for solubilising these molecules, which generally comprise groups of low polarity, such as aliphatic or aromatic groups or one or more non-ionised functional groups, such as: —NH₂; —COOH; SO₃H, etc. Lastly, these molecules are preferably soluble in an apolar solvent.

In conclusion, to develop a molecular electrolytic solution, the solvent should be both polar and apolar and should have an increased relative permittivity. Unfortunately, a solvent having these parameters does not exist. The following examples are indicative of this problem. The conventional salts, such as NaCl, KCl, Na₂SO₄ are very soluble in polar solvents of increased relative permittivity. It should be noted that, due to the combination of these two parameters (polarity and permittivity), water is the only solvent capable of forming a solution of which the ionic conductivity makes it possible to achieve current strengths of 1 A·cm⁻² between two electrodes immersed in this solution. Unfortunately, water is a solvent that is not very effective in solubilising organic molecules containing apolar groups.

Conversely, an organic solvent that is very solubilising for the organic molecules, such as dichloromethane, will not dissolve a conventional ionic salt, or will only dissolve such a salt poorly, which makes it a very poor conductor of current. However, intermediate solvents exist, such as DMSO, which can dissolve both organic molecules and ionic salts. Due to the weakness of its relative permittivity, however, DMSO is a solvent that hardly brings about any dissociation, which does not lead to many charges in solution, which limits the ionic conductivity of the medium.

Consequently, the increase in solubility can only be provided, currently, by modifying the nature of the electrolytic salt or of the organic molecule. These two transformations, however, quickly reveal their limits:

Electrolytic Salt:
the organic molecules are preferably soluble in the organic solvents (dichloromethane, acetonitrile, etc.) and consequently the concern is to solubilise positive and negative charges in the organic medium so as to provide an electrolytic solution. One solution is to use molecular ions in which the positive or negative charge is protected by an apolar environment. This is the case for example for tetra-n-butylammonium hexafluorophosphate.
In fact, in the case of tetra-n-butylammonium, for each ion the charge is confined to the centre of the molecular structure and, taking into account the apolar environment, the surface charge density is low, which leads to an affinity of these ions with an organic solvent of high polarity or low polarity. This method leads to good solubilisation of the salt, but to a low dissociation of ions. The conductivity of the solution remains low and, taking into account the very high purchase price of these salts, the provision of an industrial electrolytic process in these conditions seems unlikely. This technique is only expressed at analytical level, which utilises only low solution volumes in the cm³ range.

Organic Molecules:
this strategy is the opposite of the previous one. It is based on consideration of the solvent with which the ionic conductivity is greatest. This is case with water, which is the best candidate because the dissolution at high concentration of non-organic ionic salts (NaCl, Na₂SO₄, etc.) does not pose any problems. In addition, the pH of the solution can be controlled by using the OH⁻ or H₃O⁺ ions released by the mineral compounds; NaOH, KOH, HCl, H₂SO₄, etc. In this case, the solubilisation of an organic molecule can only be performed in certain conditions.
   When the molecule carries —OH functions (in the case of sugars) or to a lesser extent SH functions (in the case of some amino acids).
   When the following ionisable functions appear in the solution: —NH₃⁺, —COO⁻, —SO₃⁻.

This strategy is satisfactory in the case of organic molecules of low molecular weight, in which case the interaction with water and the solubilising function is strong. By contrast, as soon as the aliphatic chains and the aromatic cycles increase in size (which is the general case), it is imperative that they are accompanied by numerous ionising functions so as to assure the solubility of the molecule. Consequently, it is necessary to provide successive chemical synthesis steps so as to functionalise the target molecule. This method is difficult, and the cost rises depending on the scheduled number of steps. In addition, there is the risk that once the various modifications have been made, they will lead to a modification of the original chemical properties of the molecule.

The solubilisation of an electroactive organic molecule in a current-conducting solution is therefore a major problem when carrying out electrochemical processes. This difficulty is associated with the solubilisation, in the same solvent, of a support electrolyte and of an organic molecule having different physico-chemical properties. The most suitable method is that of chemically modifying the organic molecule or the support electrolyte so as to optimise their affinities with a suitable solvent. This increase in solubility, however, is based on the need to provide a number of chemical synthesis steps, which quickly prove to be onerous.

Consequently, in an industrial context, this method is unsuitable for providing high-volume molecular electrolytic solutions with elevated molecular concentrations.

Thus, one of the aims of the invention is to increase the solubility of an organic molecule soluble or poorly soluble in aqueous solution without multiplying the synthesis steps.

A further aim of the invention is to solubilise an organic molecule insoluble in aqueous solution without multiplying the synthesis steps.

A further aim of the invention is to provide a process for aqueous solubilisation of an organic molecule.

A further aim of the invention is to provide an electrolytic device for carrying out a process of electrochemical storage.

The present invention also relates to the use of at least one ionic liquid to increase the solubility of at least one organic molecule in aqueous solution containing at least one inorganic salt and to obtain an electrolytic solution, wherein said at least one ionic liquid and said at least one organic molecule are present in said aqueous solution in at least substantially stoichiometric quantities.

The inventors have found, surprisingly, that the addition of an at least substantially stoichiometric quantity of an ionic liquid to at least one organic molecule soluble or poorly soluble in aqueous solution makes it possible to increase the solubility in aqueous solution of said molecule.
Within the sense of the present invention, the expression “increase the solubility of at least one organic molecule” means that the organic molecule, in the aqueous solution in question, is insoluble, poorly soluble, or soluble in the absence of ionic liquid.
For insoluble organic molecules, the addition of the ionic liquid makes it possible to achieve a concentration of 0.1 M of the organic molecule in aqueous solution.
For poorly soluble or soluble organic molecules, the addition of the ionic liquid makes it possible to multiply the concentration in aqueous solution of the organic molecule by 1.5; 2; 2.5; 3; 3.5; 4; 4.5 or even 5. This factor of increase in solubility in aqueous solution is dependent on the molecular weight of the organic molecule in question.
The term “aqueous solution” means a liquid phase comprising primarily water. This liquid phase may optionally also contain one or more additives. An additive is a compound, or mixture of compounds, added in small quantity, the role of which is to modify the properties of the solution. Within the sense of the invention, the term “additive” furthermore means anything not already included in the electrolytic solution of the invention, that is to say a compound, or mixture of compounds, other than an ionic liquid, an organic molecule, or an inorganic salt (as defined hereinafter). An additive of the invention is for example selected from an organic solvent soluble with water (DMSO, acetonitrile, methanol, ethanol, etc.) or a mixture of a weak acid and its conjugate base so as to form an acid buffer solution or a mixture of a weak base and its conjugate acid so as to form a basic buffer solution. The term “buffer solution” is understood to mean a solution of which the pH is held approximately constant in spite of the addition of small quantities of an acid or a base, or in spite of a dilution. The term “the pH is held approximately constant” means that a deviation less than or equal to 1 pH unit can be observed. An “acid buffer solution” denotes a buffer solution of which the pH is from 1 to 7. A “basic buffer solution” denotes a buffer solution of which the pH is from 7 to 13. The proportion of additives in the liquid phase does not exceed 2 mol·L⁻¹.
The term “a liquid phase comprising primarily water” comprises a liquid phase composed of at least 70% water.
The terms “electrolytic solution” refer to an aqueous solution containing ions. Within the sense of the present invention, this term defines a solution of which the electrical conductivity is greater than or equal to 40 mS·cm⁻¹.
An “ionic liquid” is a salt, formed by the association of a cation and of an anion, in the liquid state at a temperature generally less than 100° C., advantageously at a temperature less than or equal to the ambient temperature.
The ionic liquid of the invention is an adjuvant since it is introduced in a quantity largely smaller than that of the solvent. Its purpose is to modulate the solubility of organic molecules in water.
The ionic liquid of the invention is therefore an adjuvant having a solubilising role, not to be confused with a solvent due to its proportion in the electrolytic solution.
Within the sense of the present invention, the term “in at least substantially stoichiometric quantities” means that the ratio of the molar quantities of ionic liquids and organic molecules is at least 0.8. This ratio can reach a value of 5. The upper limit of this ratio is such that it is possible to preserve an electrical conductivity of the electrolytic solution greater than or equal to 40 mS·cm⁻¹. In the invention, the ratio of the molar quantities of ionic liquids and organic molecules may therefore assume the following values, for example: 0.8; 0.9; 1; 1.5; 2; 2.5; 3; 3.5; 4; 4.5 or 5.
When the ionic liquid is introduced in too large a quantity into the solution, the electrochemical response decreases significantly on account of a drop in the electrical conductivity of the solution. Indeed, beyond a concentration of ionic liquid 5 times greater than the concentration of organic molecule, the electrical resistance of the electrolytic solution increases very rapidly. Under these conditions, these mixtures become unsuitable for use in an electrochemical process in which strong currents develop.
Conversely, for a ratio of the molar quantities of ionic liquids and organic molecules less than 0.8, the electrochemical response is improved. However, the solution rapidly becomes increasingly “pasty” and starts to solidify after a few minutes. The ionic liquid under these conditions is no longer able to fulfil its solubilising role.
The “electrical conductivity”, expressed in S·cm⁻¹, defines the ability of a solution to allow the electrical charges to move freely and thus allow the passage of an electrical current. Thus, the notions of electrical conductivity and of mobility of ions are linked and vary simultaneously. The notion of electrical conductivity is additionally the opposite of the notion of “electrical resistance”, which reflects the property of a component to oppose the passage of an electrical current.
In accordance with one embodiment, the invention relates to the use of at least one ionic liquid to increase the solubility of at least one organic molecule poorly soluble or soluble in aqueous solution containing at least one inorganic salt and to obtain an electrolytic solution, wherein said at least one ionic liquid and said at least one organic molecule are present in said aqueous solution in at least substantially stoichiometric quantities.
The expression “increase the solubility of at least one poorly soluble or soluble organic molecule” means that the organic molecule is poorly soluble or soluble in the aqueous solution in question in the absence of ionic liquid.
The addition of the ionic liquid thus makes it possible to multiply the concentration in aqueous solution of the organic molecule by 1.5; 2; 2.5; 3; 3.5; 4; 4.5 or even 5. This factor of increase in solubility in aqueous solution is dependent on the molecular weight of the organic molecule in question.
In accordance with one embodiment, the invention relates to the use of at least one ionic liquid to increase the solubility of at least one organic molecule in aqueous solution containing at least one inorganic salt and to obtain an electrolytic solution, wherein said at least one ionic liquid and said at least one organic molecule are present in said aqueous solution in substantially stoichiometric quantities.
The inventors have found, surprisingly, that the addition of a substantially stoichiometric quantity of an ionic liquid to at least one organic molecule soluble or poorly soluble in aqueous solution makes it possible to increase the solubility in aqueous solution of said molecule. Within the sense of the present invention, the term “in substantially stoichiometric quantities” means that the ratio of the molar quantities of ionic liquids and organic molecules is from at least 0.8 to a value of 1.2.
Under these conditions, the electrical conductivity of the electrolytic solution is optimal. In accordance with one embodiment, the invention relates to the use of at least one ionic liquid to solubilise at least one organic molecule in an aqueous solution containing at least one inorganic salt and to obtain an electrolytic solution, wherein said at least one ionic liquid and said at least one organic molecule are present in said aqueous solution in at least substantially stoichiometric quantities.
The inventors have found, surprisingly, that the addition of an at least substantially stoichiometric quantity of an ionic liquid to at least one organic molecule insoluble in aqueous solution makes it possible to increase the solubility in aqueous solution of said molecule.
The expression “solubilise at least one organic molecule” refers to the aqueous solubilisation of an organic molecule insoluble in aqueous solution.
The expression “organic molecule insoluble in aqueous solution” is considered, within the sense of the invention, to mean that the organic molecule has a solubility less than 0.1 M in aqueous solution, in the absence of ionic liquid. The addition of the ionic liquid makes it possible to achieve a concentration of 0.1 M of the organic molecule in aqueous solution.

In accordance with one embodiment of the invention, with use of at least one ionic liquid, said at least one ionic liquid comprises a hydrophilic anion.

In accordance with an advantageous embodiment of the invention, with use of at least one ionic liquid, said hydrophilic anion is selected from the methane sulfate, ethane sulfate, chloride, iodide, tetrafluoroborate, thiocyanate, dicyanamide, trifluoroacetate, nitrate or hexafluorophosphate anion.
In accordance with an advantageous embodiment of the invention, with use of at least one ionic liquid, said hydrophilic anion is selected from the methane sulfate, ethane sulfate, tetrafluoroborate or dicyanamide anion.
In accordance with one embodiment of the invention, with use of at least one ionic liquid, said at least one ionic liquid comprises an aromatic heterocyclic cation.
In accordance with an advantageous embodiment of the invention, with use of at least one ionic liquid, said at least one ionic liquid comprises an aromatic heterocyclic cation, said at least one ionic liquid comprises an aromatic heterocyclic cation selected from an imidazolium, a pyridinium or a quinolinium.
In accordance with an advantageous embodiment of the invention, with use of at least one ionic liquid, said at least one ionic liquid comprises a hydrophilic anion and an aromatic heterocyclic cation.
In accordance with a preferred embodiment of the invention, with use of at least one ionic liquid, said at least one ionic liquid is selected from the pyridinium ethane sulfate of formula (I-a), the imidazolium ethane sulfate of formula (I-b), the imidazolium methane sulfate of formula (I-c), the imidazolium dicyanamide of formula (I-d), the imidazolium tetrafluoroborate of formula (I-e) or the quinolinium methane sulfate of formula (I-f):

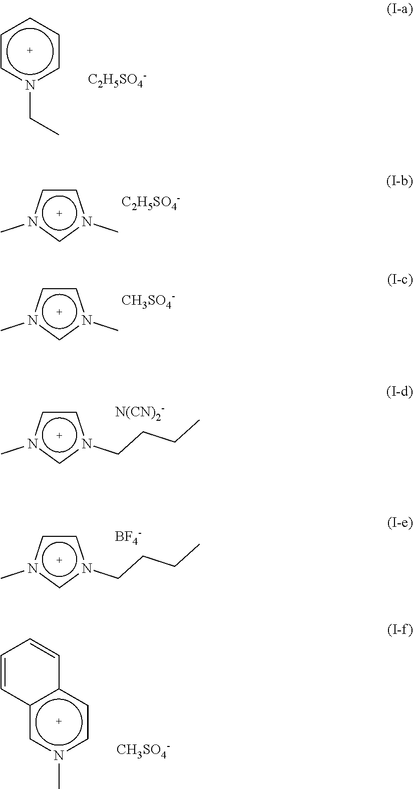

In accordance with another embodiment of the invention, with use of at least one ionic liquid, said at least one ionic liquid comprises an aliphatic cation.
In accordance with an advantageous embodiment of the invention, with use of at least one ionic liquid, said at least one ionic liquid comprises an aliphatic cation selected from an ammonium. In accordance with an advantageous embodiment of the invention, with use of at least one ionic liquid, said at least one ionic liquid comprises a hydrophilic anion and an aliphatic cation.
In accordance with a preferred embodiment of the invention, with use of at least one ionic liquid, said at least one ionic liquid is the ammonium methane sulfate of formula (I-g):

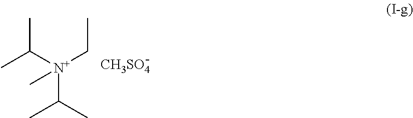

In accordance with one embodiment of the invention, with use of at least one ionic liquid according to the invention, said at least one ionic liquid comprises a hydrophilic anion and an aromatic heterocyclic cation or an aliphatic cation:
said hydrophilic anion being selected in particular from the methane sulfate, ethane sulfate, chloride, iodide, tetrafluoroborate, thiocyanate, dicyanamide, trifluoroacetate, nitrate or hexafluorophosphate anion, preferably selected from the methane sulfate, ethane sulfate, tetrafluoroborate or dicyanamide anion;
said aromatic heterocyclic cation being selected in particular from an imidazolium, a pyridinium or a quinolinium; or said aliphatic cation being in selected in particular from an ammonium;
said at least one ionic liquid being selected more preferably from the pyridinium ethane sulfate of formula (I-a), the imidazolium ethane sulfate of formula (I-b), the imidazolium methane sulfate of formula (I-c), the imidazolium dicyanamide of formula (I-d), the imidazolium tetrafluoroborate of formula (I-e), the quinolinium methane sulfate of formula (I-f), or the ammonium methane sulfate of formula (I-g).
   It is also possible to use a number of ionic liquids as adjuvant, in particular depending on their properties. Indeed, an ionic liquid might have a strong affinity with the organic molecules to be solubilised, but its melting point or its viscosity might be too high to obtain a solution. In this case, a second ionic liquid having more suitable properties may be added in order to obtain a solution whilst increasing the solubilising power of the adjuvant. In this case, the ionic liquid makes it possible to modulate both the solubility of the at least one organic molecule and the viscosity of the electrolytic solution.
   The “viscosity” is defined as the resistance to uniform and turbulent-free flow in the mass of a material. When the viscosity increases, the ability of the fluid to flow decreases. The ions possibly present in the fluid thus move with an increased resistance. A rise in the viscosity is thus also associated with a reduction in the electrical conductivity of a solution.
   In accordance with one embodiment of the invention, with use of at least one ionic liquid, said electrolytic solution comprises two different ionic liquids.
   In accordance with an advantageous embodiment of the invention, with use of at least one ionic liquid, said electrolytic solution comprises two different ionic liquids, the two ionic liquids being present in equivalent molar quantity and being present together in a stoichiometric quantity in relation to said at least one organic molecule.
   In accordance with one embodiment, with use of at least one ionic liquid according to the invention, said at least one ionic liquid is present in a volume percentage of from 5 to 20% in relation to the total volume of the solution, in particular of from 10 to 20%, particularly of 10%. Below 5 vol. %, the ionic liquid is not introduced in a quantity relative to the organic molecule sufficient to assure its role as solubilising adjuvant.
   For a value of from 5 vol. % to a value less than 10 vol. %, the addition of ionic liquid makes it possible to increase the solubility of an organic molecule in the aqueous solution without necessarily reaching the maximum solubility of the organic molecule in water. This maximum is obtained by an addition of ionic liquid corresponding to 10 vol. % relative to the total volume of the solution.
   Thus, the obtained solubilisation of the organic molecule is maximum for a stoichiometric ratio equal to 1. By contrast, when the number of moles of ionic liquid is less than half that of the organic molecule, solubilisation is no longer possible.
   By way of example, alizarin is soluble at a concentration of 0.1 M in an aqueous solution of KOH 2 M. With an addition of 10% ionic liquid, the concentration of alizarin in the aqueous solution of KOH 2 M rises to 0.5 M. However, 5% ionic liquid makes it possible to solubilise 0.25 M of alizarin, which corresponds to a concentration greater than the concentration of alizarin in the aqueous solution of KOH 2 M without addition of ionic liquid, but a concentration lower than that obtained by the addition of 10 vol. % of ionic liquid.
   Beyond 20 vol. %, the ionic liquid is considered to be a solvent within the sense of the invention. A percentage of ionic liquid greater than 20 vol. % in relation to the total volume of the solution therefore does not form part of the invention.

In accordance with one embodiment of the invention, with use of at least one ionic liquid, said at least one organic molecule is polar or apolar.

The terms “polar” and “apolar” refer to the difference in electronegativity between the atoms forming the organic molecule. The electronegativity of an element is its tendency to attract electrons towards it.
In accordance with an advantageous embodiment of the invention, with use of at least one ionic liquid, said at least one organic molecule is polar.
In accordance with another advantageous embodiment of the invention, with use of at least one ionic liquid, said at least one organic molecule is apolar.
In accordance with one embodiment of the invention, with use of at least one ionic liquid, said at least one organic molecule is electroactive.
Within the sense of the present invention, the term “electroactive organic molecule” means the ability of an organic molecule to be reversibly oxidised and/or reduced. The reversibility is evidenced by the difference between the oxidation and reduction potential of a species. A difference of 57 mV at 25° C. characterises a phenomenon of reversible oxidoreduction.
In accordance with one embodiment of the invention, with use of at least one ionic liquid, said at least one organic molecule has a molecular weight of from 100 to 600 g·mol⁻¹.
This range includes organic molecules referred to as “small” and “large”.
In accordance with one embodiment of the invention, with use of at least one ionic liquid, said at least one organic molecule has a molecular weight of from 100 to 200 g·mol⁻¹.
An organic molecule within the sense of the present invention of which the molecular weight is from 100 to 200 g·mol⁻¹ is considered to be a “small” organic molecule. This class of molecule generally has a solubility in a water devoid of ionic liquid of from 0.2 M to 0.5 M. In accordance with another embodiment of the invention, with use of at least one ionic liquid, said at least one organic molecule has a molecular weight of from 200 to 600 g·mol⁻¹.
The organic molecules of which the molecular weight is from 200 to 600 g·mol⁻¹ are considered within the sense of the invention to be “large” molecules. Their solubility in a water devoid of ionic liquid is generally from 0 M to 0.2 M.
Beyond 600 g·mol⁻¹, the organic molecule induces an excessively high viscosity of the aqueous solution, reducing the conductivity of the solution below the threshold of 40 mS·cm⁻¹ defining an electrolytic solution within the sense of the present invention.
In accordance with one embodiment, with use of at least one ionic liquid according to the invention, said at least one organic molecule has from 1 to 4 fused aromatic rings, preferably from 1 to 3 fused aromatic rings, more preferably 1 aromatic ring or 3 fused aromatic rings. Beyond 4 fused aromatic rings, the intermolecular interactions are too strong to allow an ionic liquid added in an at least substantially stoichiometric quantity to solubilise the organic molecule in aqueous solution.
In accordance with an advantageous embodiment of the invention, with use of at least one ionic liquid, said at least one organic molecule is selected from the family of quinones, catechols, naphthoquinones, orthonaphthoquinones or anthraquinones.
In accordance with a more advantageous embodiment of the invention, with use of at least one ionic liquid, said at least one organic molecule is selected from the family of quinones, catechols, naphthoquinones or orthonaphthoquinones. The organic molecules from these families belong to the category of “small” molecules within the sense of the invention.
In accordance with another, more advantageous embodiment of the invention, with use of at least one ionic liquid, said at least one organic molecule is selected from the family of anthraquinones.
The molecules from the family of anthraquinones belong to the category of “large” molecules. In accordance with an advantageous embodiment, with use of at least one ionic liquid according to the invention, said at least one organic molecule is hydroxylated in at least one position.
The inventors have found that, with the presence of a hydroxyl group close to one of the two carbonyl functions, that is to say at the alpha or beta position of one of the two carbonyl functions, the electrochemical reversibility of the molecule is assured. In addition, the presence of a hydroxyl function improves the solubility in water and particularly in basic medium.
In accordance with an advantageous embodiment, with use of at least one ionic liquid according to the invention, said at least one organic molecule is hydroxylated in at least one position and has a molecular weight of from 100 to 200 g·mol⁻¹.
In accordance with an advantageous embodiment, with use of at least one ionic liquid according to the invention, said at least one organic molecule is hydroxylated in at least one position and has a molecular weight of from 200 to 600 g·mol⁻¹.
In accordance with a preferred embodiment of the invention, with use of an ionic liquid, said at least one organic molecule is selected from the compounds of formulas (II-a) to (II-i):

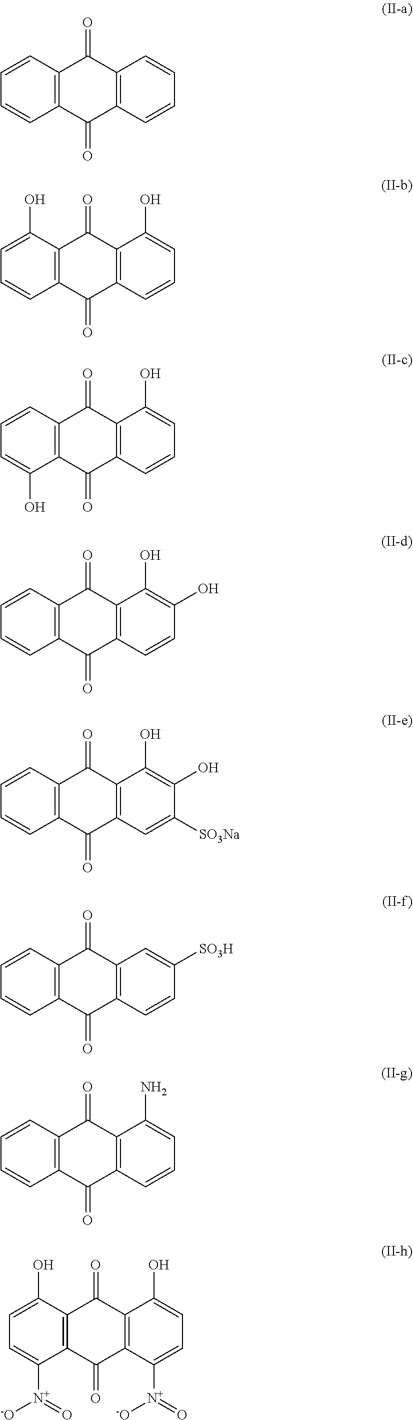

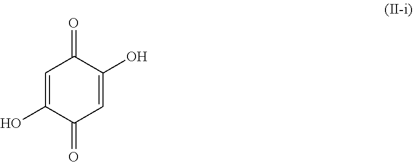

In accordance with one embodiment of the invention, with use of at least one ionic liquid, said at least one organic molecule is polar or apolar; and/or
said at least one organic molecule is electroactive; and/or
said at least one organic molecule has a molecular weight of from 100 to 600 g·mol⁻¹, in particular of from 100 to 200 g·mol⁻¹, or of from 200 to 600 g·mol⁻¹; and/or
said at least one organic molecule has in particular from 1 to 4 fused aromatic rings, preferably from 1 to 3 fused aromatic rings, more preferably 1 aromatic ring or 3 fused aromatic rings; and/or
said at least one organic molecule is hydroxylated in at least one position;
in particular said at least one organic molecule is selected from the family of quinones, catechols, naphthoquinones, orthonaphthoquinones or anthraquinones, preferably selected from the compounds of formulas (II-a) to (II-i).
   In accordance with one embodiment of the invention, with use of at least one ionic liquid, said at least one organic molecule has a solubility in a water devoid of ionic liquid of from 0 M to a value less than 0.1 M.
   The organic molecule thus defined is considered to be insoluble in a water devoid of ionic liquid within the sense of the present invention.
   The invention is based in particular on the unexpected observation by the inventors of an increase up to 0.1 M of the solubility in a water devoid of ionic liquid of an organic molecule of this kind when 5 equivalents of ionic liquid in relation to the organic molecule are added. Within the sense of the present invention, the expression “solubility in a water devoid of ionic liquid” refers to the solubility of the organic molecule in an aqueous solution as defined in the present invention, in the absence of ionic liquid.
   In accordance with another embodiment of the invention, with use of at least one ionic liquid, said at least one organic molecule has a solubility in a water devoid of ionic liquid of from 0.1 M to 0.2 M.
   The organic molecule thus defined is considered to be poorly soluble in a water devoid of ionic liquid within the sense of the present invention.
   The invention is based in particular on the unexpected observation by the inventors of an increase in the solubility of the organic molecule poorly soluble in a water devoid of ionic liquid with addition of a stoichiometric quantity of ionic liquid in relation to the organic molecule. The addition of the ionic liquid multiplies the solubility of the organic molecule in the aqueous solution by 3 or 5.
   In accordance with another embodiment of the invention, with use of at least one ionic liquid, said at least one organic molecule has a solubility in a water devoid of ionic liquid of from 0.2 M to 0.5 M.
   The organic molecule thus defined is considered to be soluble in a water devoid of ionic liquid within the sense of the present invention.
   The invention is based in particular on the unexpected observation by the inventors of an increase in the solubility of the organic molecule soluble in a water devoid of ionic liquid up to a solubility of 1 M by the addition of a stoichiometric quantity of ionic liquid in relation to the organic molecule.
   Beyond a solubility of 0.5 M of electroactive organic molecule in a water devoid of ionic liquid, the electrolytic solutions containing an organic molecule of this kind can be used without addition of ionic liquid in a battery.
   In accordance with one embodiment of the invention, with use of at least one ionic liquid, said at least one organic molecule has a solubility in a water devoid of ionic liquid of from 0 M to a value less than 0.1 M; or
said at least one organic molecule has a solubility in a water devoid of ionic liquid of from 0.1 M to 0.2 M; or
said at least one organic molecule has a solubility in a water devoid of ionic liquid of from 0.2 M to 0.5 M.

In accordance with one embodiment, with use of at least one ionic liquid according to the invention, said at least one ionic liquid and said at least one organic molecule are present each in a concentration of from 0.1 M to 1 M, preferably from 0.1 M to 0.6 M.

Under these concentration conditions, the ionic liquid is an adjuvant within the sense of the invention and cannot be considered a solvent.
In accordance with one embodiment of the invention, with use of at least one ionic liquid, said at least one inorganic salt is an acidic, basic or neutral salt.
In accordance with one embodiment of the invention, with use of at least one ionic liquid, said at least one inorganic salt is a strong neutral salt selected from NaCl, KCl, Na₂SO₄, K₂SO₄.
In accordance with another embodiment of the invention, with use of at least one ionic liquid, said at least one inorganic salt is a strong acid selected from HCl, H₂SO₄, HClO₄.
The strong acids make it possible to obtain at high concentration, that is to say at a concentration greater than or equal to 1 M, an elevated conductivity of the solution, since the charges (anions and protons) are completely dissociated. Within the sense of the invention, it is possible to define a conductivity as “elevated” if a current of 1 A circulates between the two electrodes of 1 cm² surface and arranged 1 cm away from one another. This value is obtained when the charged particle in solution is the proton, which is the most mobile species of all the ions (before OH⁻).
At a pH lower than or equal to 1, the pH of the electrolytic solution hardly changes, without addition of an additive. Under these conditions, only the ions H⁺ assure the electrical conductivity of the solution, which is then qualified as being elevated.
The solutions of which the pH is greater than 1 and less than or equal to 7 are buffered with the aid of an additive comprising a mixture of a weak acid and its conjugate base, that is to say the pH of the solution will change very little.
The mixture of a weak acid and its conjugate base and the proportions thereof making it possible to obtain buffer solutions of which the pH is between a value greater than 1 and a value less than or equal to 7 are known to a person skilled in the art. For example, the mixture CH₃COOH/CH₃COO⁻,Na⁺ makes it possible to obtain buffer solutions of which the pH is from 3.8 to 5.8. For solutions of which the pH is from 1.9 to 3.9, a mixture of ClCH₂COOH/ClCH₂COO⁻,Na⁺ can be selected. The buffer solution advantageously has a concentration of from 0.1 to 2 M of the mixture of a weak acid and its conjugate base.
In a buffered acidic aqueous solution with the mixture CH₃COOH/CH₃COO⁻,Na⁺ the electrical conductivity is assured by the mobility of the ions present in majority, that is to say CH₃COO⁻ et Na⁺. The ions CH₃COO⁻ and Na⁺ being larger than the proton H⁺, they move more slowly in solution and contribute to a reduction of the electrical conductivity compared to a non-buffered acidic aqueous solution of which the pH is less than or equal to 1.
In order to assure a good ionic conductivity, at least one buffer solution 2 M which frees 1 M of positive and negative charge in solution is required.
Lastly, a conductive buffer solution is very concentrated in various inorganic and organic ions, which hampers the solubility of an organic molecule. In this case, the solution can be buffered for example between 0.1 and 0.5 M, and the conductivity of the medium is increased by the addition of a neutral inorganic salt.
In accordance with another embodiment of the invention, with use of at least one ionic liquid, said at least one inorganic salt comprises two inorganic salts.
In accordance with an advantageous embodiment of the invention, with use of at least one ionic liquid, said two inorganic salts are selected from a neutral inorganic salt and an acidic inorganic salt.
In particular, the neutral inorganic salt is selected from NaCl, KCl, Na₂SO₄, K₂SO₄ and the acidic inorganic salt is selected from the strong acids HCl, H₂SO₄, HClO⁴.
In accordance with another embodiment of the invention, with use of at least one ionic liquid, said at least one inorganic salt is a strong base selected from NaOH, KOH, LiOH.
At a pH greater than or equal to 13, the pH of the electrolytic solution hardly changes, without addition of an additive. Under these conditions, only the ions HO⁻ assure the electrical conductivity of the solution.
The solutions of which the pH is greater than or equal to 7 and less than 13 are buffered with the aid of an additive comprising a mixture of a weak base and its conjugate acid, that is to say the pH of the solution will change very little. The mixtures of a weak base and its conjugate acid and the proportions thereof making it possible to obtain buffer solutions of which the pH is between a value greater than or equal to 7 and less than 13 are known to a person skilled in the art. The buffer also contributes to assuring the conductivity of the electrolytic solution. In this case the electrical conductivity, however, remains reduced compared to the electrical conductivity of a non-buffered basic solution, but can be increased by the addition of a basic inorganic salt. The use of at least one ionic liquid according to the invention thus involves two inorganic salts.
In accordance with an advantageous embodiment of the invention, with use of at least one ionic liquid, said two inorganic salts are selected from a neutral inorganic salt and a basic inorganic salt.
In particular, the neutral inorganic salt is selected from NaCl, KCl, Na₂SO₄, K₂SO₄ and the basic inorganic salt is selected from the strong bases NaOH, KOH, LiOH.
In a solution of strong acid or strong base, the addition of a strong neutral salt (completely dissociated) makes it possible to increase the conductivity without increasing the already significant quantity (at least 0.5 mol·L⁻¹) of protons or hydroxides.
In accordance with one embodiment of the invention, with use of at least one ionic liquid, said inorganic salt has a concentration of from 0.5 to 3 M, more particularly of from 1 M to 2.5 M, preferably of 2 M.
Below 0.5 M, the quantity of ions in the aqueous solution is too low to achieve the conductivity of 40 mS·cm¹ of the electrolytic solution of the invention.
Beyond 3 M of inorganic salts, and depending on their nature, a number of phenomena can appear, since the electrolytic solutions of the invention are highly charged with molecules and ions (organic molecule+ionic liquid+inorganic salts). Thus, 1) the inorganic salt may be at its limit of solubility in the solution in question, 2) the inorganic salt may saturate the solution and its excess may result in the insolubility of the organic molecule, 3) beyond the saturation of the inorganic salt, two liquid phases of different density may appear.
In accordance with one embodiment of the invention, with use of at least one ionic liquid according to the invention, said at least one inorganic salt is an acidic, basic or neutral salt;
in particular said at least on inorganic salt is a strong neutral salt selected from NaCl, KCl, Na₂SO₄, K₂SO₄; or
said at least one inorganic salt is a strong acid selected from HCl, H₂SO₄, HClO₄, in particular said at least one inorganic salt comprises two inorganic salts, in particular selected from a neutral inorganic salt and an acidic inorganic salt, preferably the neutral inorganic salt is selected from NaCl, KCl, Na₂SO₄, K₂SO₄ and the acidic inorganic salt is selected from the strong acids HCl, H₂SO₄, HClO₄; or
said at least one inorganic salt being a strong base selected from NaOH, KOH, LiOH, in particular said at least one inorganic salt comprises two inorganic salts, in particular selected from a neutral inorganic salt and a basic inorganic salt, preferably the neutral inorganic salt is selected from NaCl, KCl, Na₂SO₄, K₂SO₄ and the basic inorganic salt is selected from the strong bases NaOH, KOH, LiOH;
in particular said inorganic salt has a concentration of from 0.5 to 3 M, more particularly of from 1 M to 2.5 M, preferably of 2 M.

In accordance with one embodiment of the invention, with the use of at least one ionic liquid, said electrolytic solution has an electrical conductivity a greater than 40 mS·cm⁻¹, in particular greater than 100 mS·cm⁻¹, preferably of from 100 to 200 mS·cm⁻¹.

Below 40 mS·cm⁻¹, the conductivity becomes low, as does also the intensity of the current between two electrodes. Thus, in an electrolysis process, if the current is low, the speed of transformation of a product is also low, and the duration of the electrolysis is very long. This procedure cannot be applicable to an industrial process.
The same is true for a battery or a cell: if the conductivity is low, the current produced is low. Conversely, the higher the conductivity, the greater the efficacy of the electrochemical process is considered to be.
In accordance with one embodiment of the invention, with the use of at least one ionic liquid, said electrolytic solution has a viscosity of from 1 to 400 cP measured at 20° C. with a shear rate of 25 s⁻¹.
1 centipoise is the viscosity of water.
In accordance with an advantageous embodiment of the invention, with the use of at least one ionic liquid, said electrolytic solution has a viscosity of from 1 to 125 cP measured at 20° C. with a shear rate of 25 s⁻¹.
Since the solvent used in the present invention is water, the viscosity of the obtained solution cannot be less than 1 cP. The upper limit is fixed at 125 cP, which corresponds to the viscosity of an electrolytic solution tested in battery mode and demonstrating minimal performance levels.
In accordance with another advantageous embodiment of the invention, with the use of at least one ionic liquid, said electrolytic solution has a viscosity between a value greater than 125 cP to a value of 400 cP, measured at 20° C. with a shear rate of 25 s⁻¹. Between a value greater than 125 cP and a value of 400 cP, the electrolytic solution belongs to the invention if the electrical conductivity is greater than 45 mS·cm¹ and the solubility of the organic molecule reaches 0.5 M in aqueous solution by the addition of an ionic liquid. This electrolytic solution is used in devices other than batteries, such as electrolysis devices.
Electrolysis is a non-spontaneous process, the reverse of cells and batteries, the energy cost of which rises with the increase in viscosity. Thus, beyond 400 cP, the energy cost associated with the execution of an electrolysis operation is too great for industrial application.
In accordance with one embodiment of the invention, with the use of at least one ionic liquid, said electrolytic solution has a half-wave potential of from −1.1 V/SCE to −0.7 V/SCE for a basic solution of which the concentration of hydroxide ions is greater than 0.5 mol·L⁻¹.
The potential for which the current is equal to half its limit value is referred to as the “half-wave potential” and is represented by the symbol E_{1/2}. Under consideration of a reversible redox couple in solution (Ox/Red), the potential of the electrode is fixed at a potential referred to as the equilibrium potential (E_{eq}) corresponding to a current intensity equal to zero. The equilibrium potential can be calculated by the Nernst relationship and is therefore a function of the concentration of the Ox and Red species in the solution. If a potential is applied (Eₐₚₚ) in the positive direction, an oxidation current appears. If a potential applied varies in the negative direction, a reduction current appears.
When the potential applied differs from the equilibrium potential and regularly deviates therefrom, a current is created and its intensity varies exponentially with the increase in the value Eₐₚₚ−E_{eq}.
Under consideration of the phenomenon of displacement of the species Ox and Red in the solution, the intensity of the current will stabilise quickly. In fact, the intensity of the current will be proportional to the speed of arrival of these species at the electrode. Consequently, even if the applied potential continues to vary, the intensity of the current remains constant (and no longer varies exponentially) and constitutes that which is known as a diffusion levelling (or plateau). The intensity of the current below this plateau is consequently the maximum value and is referred to as the limit current (ii). In conclusion, on the basis of the equilibrium potential where the current is zero until the formation of the plateau, the curve i=f(E) approximates a sigmoid, referred to as a wave. Thus, the half-wave potential will correspond to the value of the potential applied for a current intensity equal to it divided by 2 (i₁/2) situated on the curve i=f(E).
The half-wave potential is a characteristic of the Ox/Red couple.
In accordance with one embodiment, with the use of at least one ionic liquid according to the invention, said electrolytic solution has an electrical conductivity σ greater than 40 mS·cm⁻¹, in particular greater than 100 mS·cm⁻¹, preferably of from 100 to 200 mS·cm⁻¹.
said electrolytic solution has a viscosity of from 1 to 400 cP measured at 20° C. with a shear rate of 25 s⁻¹, in particular of from 1 to 125 cP measured at 20° C. with a shear rate of 25 s⁻¹, or between a value greater than 125 cP to a value of 400 cP, measured at 20° C. with a shear rate of 25 s⁻¹; and/or
said electrolytic solution has a half-wave potential of from −1.1 V/SCE to −0.7 V/SCE for a basic solution of which the concentration of hydroxide ions is greater than 0.5 mol·L⁻¹.

The invention also relates to a process for aqueous solubilisation of at least one organic molecule, comprising a step of addition of said at least one organic molecule and of at least one ionic liquid in at least substantially stoichiometric quantities to an aqueous solution possibly containing an inorganic salt.

In accordance with one embodiment of the process of the invention, the step of addition of said at least one organic molecule and of said at least one ionic liquid in at least substantially stoichiometric quantities to said aqueous solution is followed by a step of solubilisation of at least one inorganic salt in said aqueous solution.
In accordance with another embodiment of the process of the invention, a step of solubilisation of at least one inorganic salt in said aqueous solution is followed by a step of addition of said at least one organic molecule and of said at least one ionic liquid in at least substantially stoichiometric quantities to said aqueous solution.
In accordance with one embodiment of the process of the invention, the step of addition of said at least one organic molecule and of said at least one ionic liquid in at least substantially stoichiometric quantities to said aqueous solution is followed by a step of solubilisation of at least one inorganic salt in said aqueous solution.

In accordance with one embodiment, in the process of the invention, said at least one ionic liquid comprises a hydrophilic anion.

In accordance with an advantageous embodiment of the process of the invention, said hydrophilic anion is selected from the methane sulfate, ethane sulfate, chloride, iodide, tetrafluoroborate, thiocyanate, dicyanamide, trifluoroacetate, nitrate or hexafluorophosphate anion.
In accordance with a more advantageous embodiment of the invention, said hydrophilic anion is selected from the methane sulfate, ethane sulfate, tetrafluoroborate or dicyanamide anion. In accordance with one embodiment of the process of the invention, said at least one ionic liquid comprises an aromatic hydrophilic cation.
In accordance with an advantageous embodiment of the process of the invention, said at least one ionic liquid comprises an aromatic heterocyclic cation selected from an imidazolium, a pyridinium or a quinolinium.
In accordance with an advantageous embodiment of the process of the invention, said at least one ionic liquid comprises a hydrophilic anion and an aromatic heterocyclic cation.
In accordance with a preferred embodiment of the process of the invention, said at least one ionic liquid is selected from the pyridinium ethane sulfate of formula (I-a), the imidazolium ethane sulfate of formula (I-b), the imidazolium methane sulfate of formula (I-c), the imidazolium dicyanamide of formula (I-d), the imidazolium tetrafluoroborate of formula (I-e) or the quinolinium methane sulfate of formula (I-f):

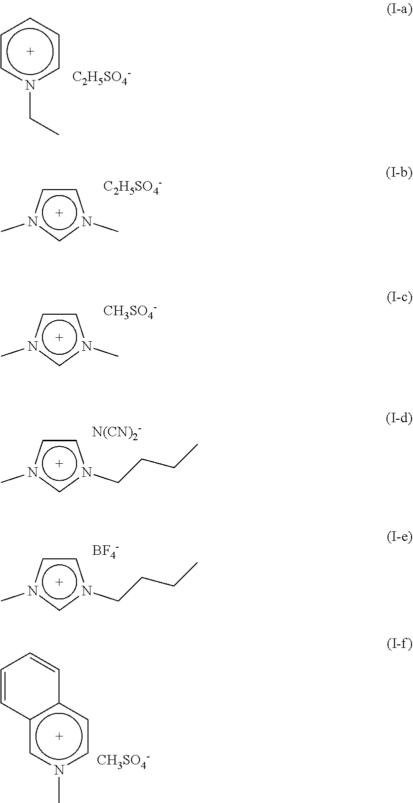

In accordance with one embodiment of the process of the invention, said at least one ionic liquid comprises an aliphatic cation.
In accordance with an advantageous embodiment of the process of the invention, said at least one ionic liquid comprises an aliphatic cation selected from an ammonium.
In accordance with an advantageous embodiment of the process of the invention, said at least one ionic liquid comprises a hydrophilic anion and an aliphatic cation.
In accordance with a preferred embodiment of the process of the invention, said at least one ionic liquid is the ammonium methane sulfate of formula (I-g):

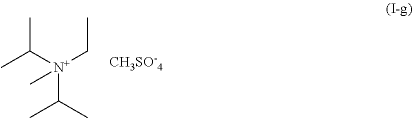

It is also possible to use a number of ionic liquids as adjuvant, in particular depending on their properties. Indeed, an ionic liquid might have a strong affinity with the organic molecules to be solubilised, but its melting point or its viscosity might be too high to obtain a solution. In this case, a second ionic liquid having more suitable properties may be added in order to obtain a solution whilst increasing the solubilising power of the adjuvant. In this case, the ionic liquid makes it possible to modulate both the solubility of the at least one organic molecule and the viscosity of the electrolytic solution.
In accordance with one embodiment of the process of the invention, said electrolytic solution comprises two different ionic liquids.
In accordance with an advantageous embodiment of the process of the invention, said electrolytic solution comprises two different ionic liquids, the two ionic liquids being present in equivalent molar quantity and being present together in an at least substantially stoichiometric quantity in relation to said at least one organic molecule.
In accordance with one embodiment, in the process of the invention, said at least one ionic liquid is present in a volume percentage of from 5 to 20% in relation to the total volume of the solution, in particular of from 10 to 20%, particularly of 10%.
Below 5 vol. %, the ionic liquid is not introduced in a quantity relative to the organic molecule sufficient to assure its role as solubilising adjuvant.
For a value of from 5 vol. % to a value less than 10 vol. %, the addition of ionic liquid makes it possible to increase the solubility of an organic molecule in the aqueous solution without necessarily reaching the maximum solubility of the organic molecule in water. This maximum is obtained by an addition of ionic liquid corresponding to 10 vol. % relative to the total volume of the solution.
Thus, the obtained solubilisation of the organic molecule is maximum for a stoichiometric ratio equal to 1. By contrast, when the number of moles of ionic liquid is less than half that of the organic molecule, solubilisation is no longer possible.
By way of example, alizarin is soluble at a concentration of 0.1 M in an aqueous solution of KOH 2 M. With an addition of 10% ionic liquid, the concentration of alizarin in the aqueous solution of KOH 2 M rises to 0.5 M. However, 5% ionic liquid makes it possible to solubilise 0.25 M of alizarin, which corresponds to a concentration greater than the concentration of alizarin in the aqueous solution of KOH 2 M without addition of ionic liquid, but a concentration lower than that obtained by the addition of 10 vol. % of ionic liquid.
Beyond 20 vol. %, the ionic liquid is considered to be a solvent within the sense of the invention. A percentage of ionic liquid greater than 20 vol. % in relation to the total volume of the solution therefore does not form part of the invention.

In accordance with one embodiment of the process of the invention, said at least one organic molecule is polar or apolar.

In accordance with an advantageous embodiment of the process of the invention, said at least one organic molecule is polar.
In accordance with another advantageous embodiment of the process of the invention, said at least one organic molecule is apolar.
In accordance with one embodiment of the process of the invention, said at least one organic molecule is electroactive.
In accordance with one embodiment of the process of the invention, said at least one organic molecule has a molecular weight of from 100 to 600 g·mol⁻¹.
This range includes organic molecules referred to as “small” and “large”.
In accordance with one embodiment of the process of the invention, said at least one organic molecule has a molecular weight of from 100 to 200 g·mol⁻¹.
An organic molecule within the sense of the present invention of which the molecular weight is from 100 to 200 g·mol⁻¹ is considered to be a “small” organic molecule. This class of molecule generally has a solubility in a water devoid of ionic liquid of from 0.2 M to 0.5 M. In accordance with another embodiment of the process of the invention, said at least one organic molecule has a molecular weight of from 200 to 600 g·mol⁻¹.
The organic molecules of which the molecular weight is from 200 to 600 g·mol⁻¹ are considered within the sense of the invention to be “large” molecules. Their solubility in a water devoid of ionic liquid is generally from 0 M to 0.2 M.
Beyond 600 g·mol−1, the organic molecule induces an excessively high viscosity of the aqueous solution, reducing the conductivity of the solution below the threshold of 40 mS·cm⁻¹ defining an electrolytic solution within the sense of the present invention.
In accordance with one embodiment of the process of the invention, said at least one organic molecule has from 1 to 4 fused aromatic rings, preferably from 1 to 3 fused aromatic rings, more preferably 1 aromatic ring or 3 fused aromatic rings.
Beyond 4 fused aromatic rings, the intermolecular interactions are too strong to allow an ionic liquid added in an at least substantially stoichiometric quantity to solubilise the organic molecule in aqueous solution.
In accordance with an advantageous embodiment of the process of the invention, said at least one organic molecule is selected from the family of quinones, catechols, naphthoquinones, orthonaphthoquinones or anthraquinones.
In accordance with a more advantageous embodiment of the process of the invention, said at least one organic molecule is selected from the family of quinones, catechols, naphthoquinones or orthonaphthoquinones. The organic molecules from these families belong to the category of “small” molecules within the sense of the invention.
In accordance with another more advantageous embodiment of the process of the invention, said at least one organic molecule is selected from the family of anthraquinones.
The molecules from the family of anthraquinones belong to the category of “large” molecules. In accordance with an advantageous embodiment, in the process of the invention said at least one organic molecule is hydroxylated in at least one position.
The inventors have found that, with the presence of a hydroxyl group close to one of the two carbonyl functions, that is to say at the alpha or beta position of one of the two carbonyl functions, the electrochemical reversibility of the molecule is assured. In addition, the presence of a hydroxyl function improves the solubility in water and particularly in basic medium.
In accordance with an advantageous embodiment, in the process of the invention, said at least one organic molecule is hydroxylated in at least one position and has a molecular weight of from 100 to 200 g·mol⁻¹.
In accordance with an advantageous embodiment, in the process of the invention, said at least one organic molecule is hydroxylated in at least one position and has a molecular weight of from 200 to 600 g·mol⁻¹.
In accordance with a preferred embodiment of the process of the invention, said at least one organic molecule is selected from the compounds of formulas (II-a) to (II-i):

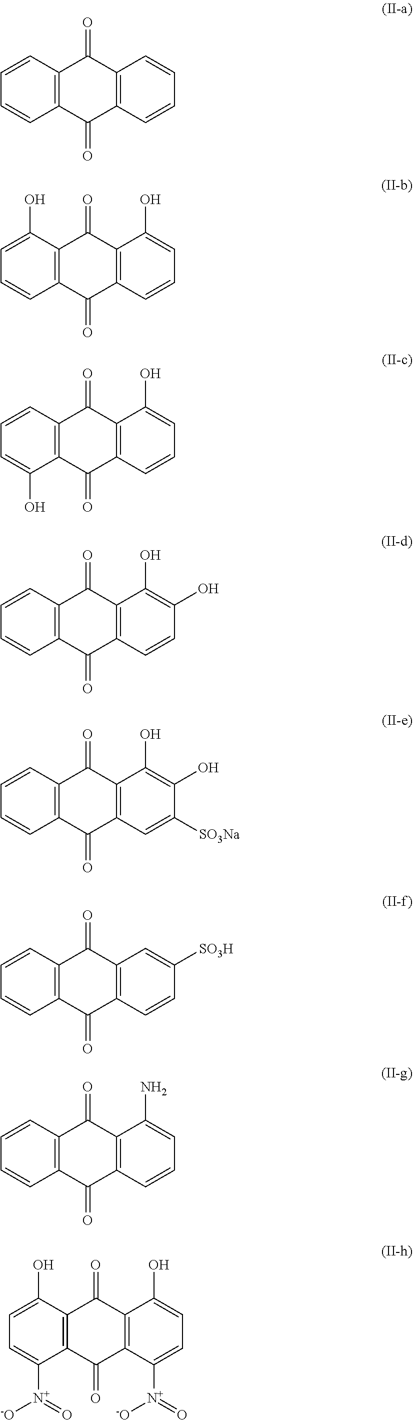

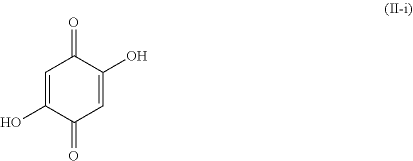

In accordance with one embodiment of the process of the invention, said at least one organic molecule has a solubility in a water devoid of ionic liquid of from 0 M to a value less than 0.1 M.
The organic molecule thus defined is considered to be insoluble in a water devoid of ionic liquid within the sense of the present invention.
The invention is based in particular on the unexpected observation by the inventors of an increase up to 0.1 M of the solubility in a water devoid of ionic liquid of an organic molecule of this kind when 5 equivalents of ionic liquid in relation to the organic molecule are added. Within the sense of the present invention, the expression “solubility in a water devoid of ionic liquid” refers to the solubility of the organic molecule in an aqueous solution as defined in the present invention, in the absence of ionic liquid.
In accordance with another embodiment of the process of the invention, said at least one organic molecule has a solubility in a water devoid of ionic liquid of from 0.1 M to 0.2 M.
The organic molecule thus defined is considered to be poorly soluble in a water devoid of ionic liquid within the sense of the present invention.
The invention is based in particular on the unexpected observation by the inventors of an increase in the solubility of the organic molecule poorly soluble in a water devoid of ionic liquid with addition of a stoichiometric quantity of ionic liquid in relation to the organic molecule. The addition of the ionic liquid multiplies the solubility of the organic molecule in the aqueous solution by 3 or 5.
In accordance with another embodiment of the process of the invention, said at least one organic molecule has a solubility in a water devoid of ionic liquid of from 0.2 M to 0.5 M.
The organic molecule thus defined is considered to be soluble in a water devoid of ionic liquid within the sense of the present invention.
The invention is based in particular on the unexpected observation by the inventors of an increase in the solubility of the organic molecule soluble in a water devoid of ionic liquid up to a solubility of 1 M by the addition of a stoichiometric quantity of ionic liquid in relation to the organic molecule.
Beyond a solubility of 0.5 M of electroactive organic molecule in a water devoid of ionic liquid, the electrolytic solutions containing an organic molecule of this kind can be used without addition of ionic liquid in a battery.

In accordance with one embodiment, in the process of the invention, said at least one ionic liquid and said at least one organic molecule are present each in a concentration of from 0.1 M to 1 M, preferably from 0.1 M to 0.6 M.

Under these concentration conditions, the ionic liquid is an adjuvant within the sense of the invention and cannot be considered a solvent.
In accordance with one embodiment of the process of the invention, said at least one inorganic salt is an acidic, basic or neutral salt.
In accordance with one embodiment of the process of the invention, said at least one inorganic salt is a strong neutral salt selected from NaCl, KCl, Na₂SO₄, K₂SO₄.
In accordance with another embodiment of the process of the invention, said at least one inorganic salt is a strong acid selected from HCl, H₂SO₄, HClO₄.
The strong acids make it possible to obtain at high concentration, that is to say at a concentration greater than or equal to 1 M, an elevated conductivity of the solution, since the charges (anions and protons) are completely dissociated. Within the sense of the invention, it is possible to define a conductivity as “elevated” if a current of 1 A circulates between the two electrodes of 1 cm² surface and arranged 1 cm away from one another. This value is obtained when the charged particle in solution is the proton, which is the most mobile species of all the ions (before 0H⁻).
At a pH lower than or equal to 1, the pH of the electrolytic solution hardly changes, without addition of an additive. Under these conditions, only the ions H⁺ assure the electrical conductivity of the solution, which is then qualified as being elevated.
The solutions of which the pH is greater than 1 and less than or equal to 7 are buffered with the aid of an additive comprising a mixture of a weak acid and its conjugate base, that is to say the pH of the solution will change very little. The mixtures of a weak acid and its conjugate base and the proportions thereof making it possible to obtain buffer solutions of which the pH is between a value greater than 1 and a value less than or equal to 7 are known to a person skilled in the art. For example, the mixture CH₃COOH/CH₃COO⁻,Na⁺ makes it possible to obtain buffer solutions of which the pH is from 3.8 to 5.8. For solutions of which the pH is from 1.9 to 3.9, a mixture of ClCH₂COOH/ClCH₂COO⁻,Na⁺ can be selected. The buffer solution advantageously has a concentration of from 0.1 to 2 M of the mixture of a weak acid and its conjugate base.
In a buffered acidic aqueous solution with the mixture CH₃COOH/CH₃COO⁻,Na⁺ the electrical conductivity is assured by the mobility of the ions present in majority, that is to say CH₃COO⁻ et Na⁺. The ions CH₃COO⁻ and Na⁺ being larger than the proton H⁺, they move more slowly in solution and contribute to a reduction of the electrical conductivity compared to a non-buffered acidic aqueous solution of which the pH is less than or equal to 1.
In order to assure a good ionic conductivity, at least one buffer solution 2M which frees 1 M of positive and negative charge in solution is required.
Lastly, a conductive buffer solution is very concentrated in various inorganic and organic ions, which hampers the solubility of an organic molecule. In this case, the solution can be buffered for example between 0.1 and 0.5 M, and the conductivity of the medium is increased by the addition of a neutral inorganic salt.
In accordance with another embodiment of the process of the invention, said at least one inorganic salt comprises two inorganic salts.
In accordance with an advantageous embodiment of the process of the invention, with use of at least one ionic liquid, said two inorganic salts are selected from a neutral inorganic salt and an acidic inorganic salt.
In particular, the neutral inorganic salt is selected from NaCl, KCl, Na₂SO₄, K₂SO₄ and the acidic inorganic salt is selected from the strong acids HCl, H₂SO₄, HClO₄.
In accordance with another embodiment of the process of the invention, said at least one inorganic salt is a strong base selected from NaOH, KOH, LiOH.
At a pH greater than or equal to 13, the pH of the electrolytic solution hardly changes, without addition of an additive. Under these conditions, only the ions HO⁻ assure the electrical conductivity of the solution.
The solutions of which the pH is greater than or equal to 7 and less than 13 are buffered with the aid of an additive comprising a mixture of a weak base and its conjugate acid, that is to say the pH of the solution will change very little. The mixtures of a weak base and its conjugate acid and the proportions thereof making it possible to obtain buffer solutions of which the pH is between a value greater than or equal to 7 and less than 13 are known to a person skilled in the art. The buffer also contributes to assuring the conductivity of the electrolytic solution. In this case the electrical conductivity, however, remains reduced compared to the electrical conductivity of a non-buffered basic solution, but can be increased by the addition of a basic inorganic salt. The use of at least one ionic liquid according to the invention thus involves two inorganic salts.
In accordance with an advantageous embodiment of the process of the invention, said two inorganic salts are selected from a neutral inorganic salt and a basic inorganic salt.
In particular, the neutral inorganic salt is selected from NaCl, KCl, Na₂SO₄, K₂SO₄ and the basic inorganic salt is selected from the strong bases NaOH, KOH, LiOH.
In a solution of strong acid or strong base, the addition of a strong neutral salt (completely dissociated) makes it possible to increase the conductivity without increasing the already significant quantity (at least 0.5 mol·L⁻¹) of protons or hydroxides.
In accordance with one embodiment of the process of the invention, said inorganic salt has a concentration of from 0.5 to 3 M, more particularly of from 1 M to 2.5 M, preferably of 2 M.
Below 0.5 M, the quantity of ions in the aqueous solution is too low to achieve the conductivity of 40 mS·cm¹ of the electrolytic solution of the invention.
Beyond 3 M of inorganic salts, and depending on their nature, a number of phenomena can appear, since the electrolytic solutions of the invention are highly charged with molecules and ions (organic molecule+ionic liquid+inorganic salts). Thus, 1) the inorganic salt may be at its limit of solubility in the solution in question, 2) the inorganic salt may saturate the solution and its excess may result in the insolubility of the organic molecule, 3) beyond the saturation of the inorganic salt, two liquid phases of different density may appear.
In accordance with one embodiment of the process of the invention, said electrolytic solution has an electrical conductivity σ greater than 40 mS·cm¹, in particular greater than 100 mS·cm⁻¹, preferably of from 100 to 200 mS·cm¹.
Below 40 mS·cm¹, the conductivity becomes low, as does also the intensity of the current between two electrodes. Thus, in an electrolysis process, if the current is low, the speed of transformation of a product will be low, and the duration of the electrolysis will be very long. This procedure cannot be applicable to an industrial process.
The same is true for a battery or a cell: if the conductivity is low, the current produced will be low.
Conversely, the higher the conductivity, the greater the efficacy of the electrochemical process is considered to be.
In accordance with one embodiment of the process of the invention, said electrolytic solution has a viscosity of from 1 to 400 cP measured at 20° C. with a shear rate of 25 s⁻¹.
1 centipoise is the viscosity of water.
In accordance with an advantageous embodiment of the process of the invention, said electrolytic solution has a viscosity of from 1 to 125 cP measured at 20° C. with a shear rate of 25 s⁻¹.
Since the solvent used in the present invention is water, the viscosity of the obtained solution cannot be less than 1 cP. The upper limit is fixed at 125 cP, which corresponds to the viscosity of an electrolytic solution tested in battery mode and demonstrating minimal performance levels.
In accordance with another advantageous embodiment of the process of the invention, said electrolytic solution has a viscosity between a value greater than 125 cP to a value of 400 cP, measured at 20° C. with a shear rate of 25 s⁻¹.
Between a value greater than 125 cP and a value of 400 cP, the electrolytic solution belongs to the invention if the electrical conductivity is greater than 45 mS·cm⁻¹ and the solubility of the organic molecule reaches 0.5 M in aqueous solution by the addition of an ionic liquid. This electrolytic solution is used in devices other than batteries, such as cells or in electrolysis devices.
Beyond 400 cP, the electrical conductivity of the solution can no longer reach 45 mS·cm¹. Under these conditions, a spontaneous device such as a cell demonstrates minimal performance levels.
Electrolysis is a non-spontaneous process, the reverse of cells and batteries, the energy cost of which rises increasingly with the increase in viscosity. Thus, beyond 400 cP, the energy cost associated with the execution of an electrolysis operation is too great for industrial application. In accordance with one embodiment of the process of the invention, said electrolytic solution has a half-wave potential of from −1.1 V/SCE to −0.7 V/SCE for a basic solution of which the concentration of hydroxide ions is greater than 0.5 mol·L⁻¹.

The invention also relates to an electrolytic device which comprises at least one ionic liquid, at least one organic molecule, at least one inorganic salt, an aqueous solution, and at least one electrode, said at least one ionic liquid and said at least one organic molecule being present in at least substantially stoichiometric quantities.

In accordance with one embodiment of the electrolytic device of the invention, said at least one electrode is selected from porous graphite electrodes or porous metal electrodes, preferably made of nickel.

In accordance with one embodiment, in the device of the invention, said at least one ionic liquid comprises a hydrophilic anion.

In accordance with an advantageous embodiment of the device of the invention, said hydrophilic anion is selected from the methane sulfate, ethane sulfate, chloride, iodide, tetrafluoroborate, thiocyanate, dicyanamide, trifluoroacetate, nitrate or hexafluorophosphate anion.
In accordance with a more advantageous embodiment of the device of the invention, said hydrophilic anion is selected from the methane sulfate, ethane sulfate, tetrafluoroborate or dicyanamide anion.
In accordance with one embodiment of the device of the invention, said at least one ionic liquid comprises an aromatic heterocyclic cation.
In accordance with an advantageous embodiment of the device of the invention, said at least one ionic liquid comprises an aromatic heterocyclic cation selected from an imidazolium, a pyridinium or a quinolinium.
In accordance with an advantageous embodiment of the device of the invention, said at least one ionic liquid comprises a hydrophilic anion and an aromatic heterocyclic cation.
In accordance with a preferred embodiment of the device of the invention, said at least one ionic liquid is selected from the pyridinium ethane sulfate of formula (I-a), the imidazolium ethane sulfate of formula (I-b), the imidazolium methane sulfate of formula (I-c), the imidazolium dicyanamide of formula (I-d), the imidazolium tetrafluoroborate of formula (I-e) or the quinolinium methane sulfate of formula (I-f):

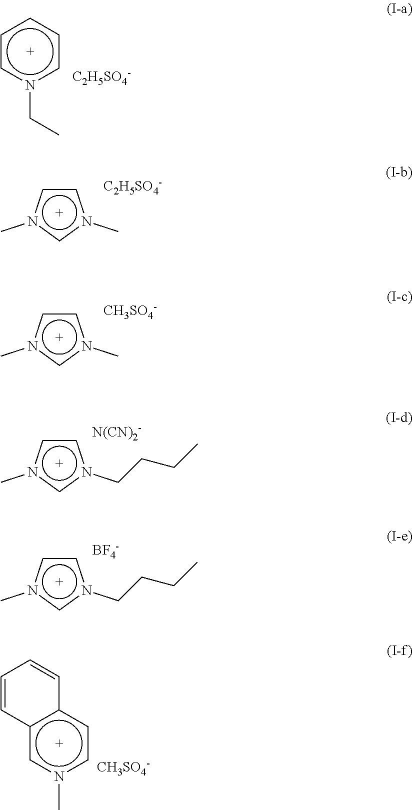

In accordance with another embodiment of the device of the invention, said at least one ionic liquid comprises an aliphatic cation.
In accordance with an advantageous embodiment of the device of the invention, said at least one ionic liquid comprises an aliphatic cation selected from an ammonium.
In accordance with an advantageous embodiment of the device of the invention, said at least one ionic liquid comprises a hydrophilic anion and an aliphatic cation.
In accordance with a preferred embodiment of the device of the invention, said at least one ionic liquid is the ammonium methane sulfate of formula (I-g):

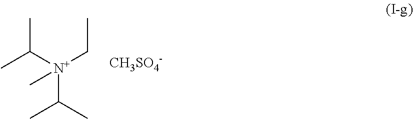

It is also possible to use a number of ionic liquids as adjuvant, in particular depending on their properties. Indeed, an ionic liquid might have a strong affinity with the organic molecules to be solubilised, but its melting point or its viscosity might be too high to obtain a solution. In this case, a second ionic liquid having more suitable properties may be added in order to obtain a solution whilst increasing the solubilising power of the adjuvant. In this case, the ionic liquid makes it possible to modulate both the solubility of the at least one organic molecule and the viscosity of the electrolytic solution.
In accordance with one embodiment of the device of the invention, said electrolytic solution comprises two different ionic liquids.
In accordance with an advantageous embodiment of the device of the invention, said electrolytic solution comprises two different ionic liquids, the two ionic liquids being present in equivalent molar quantity and being present together in an at least substantially stoichiometric quantity in relation to said at least one organic molecule.
In accordance with one embodiment, in the device of the invention, said at least one ionic liquid is present in a volume percentage of from 5 to 20% in relation to the total volume of the solution, in particular of from 10 to 20%, particularly of 10%.
Below 5 vol. %, the ionic liquid is not introduced in a quantity relative to the organic molecule sufficient to assure its role as solubilising adjuvant.
For a value of from 5 vol. % to a value less than 10 vol. %, the addition of ionic liquid makes it possible to increase the solubility of an organic molecule in the aqueous solution without necessarily reaching the maximum solubility of the organic molecule in water. This maximum is obtained by an addition of ionic liquid corresponding to 10 vol. % relative to the total volume of the solution.
Thus, the obtained solubilisation of the organic molecule is maximum for a stoichiometric ratio equal to 1. By contrast, when the number of moles of ionic liquid is less than half that of the organic molecule, solubilisation is no longer possible.
By way of example, alizarin is soluble at a concentration of 0.1 M in an aqueous solution of KOH 2 M. With an addition of 10% ionic liquid, the concentration of alizarin in the aqueous solution of KOH 2 M rises to 0.5 M. However, 5% ionic liquid makes it possible to solubilise 0.25 M of alizarin, which corresponds to a concentration greater than the concentration of alizarin in the aqueous solution of KOH 2 M without addition of ionic liquid, but a concentration lower than that obtained by the addition of 10 vol. % of ionic liquid.
Beyond 20 vol. %, the ionic liquid is considered to be a solvent within the sense of the invention. A percentage of ionic liquid greater than 20 vol. % in relation to the total volume of the solution therefore does not form part of the invention.

In accordance with one embodiment of the device of the invention, said at least one organic molecule is polar or apolar.

In accordance with an advantageous embodiment of the device of the invention, said at least one organic molecule is polar.
In accordance with another advantageous embodiment of the device of the invention, said at least one organic molecule is apolar.
In accordance with one embodiment of the device of the invention, said at least one organic molecule is electro active.
In accordance with one embodiment of the device of the invention, said at least one organic molecule has a molecular weight of from 100 to 600 g·mol⁻¹.
This range includes organic molecules referred to as “small” and “large”.
In accordance with one embodiment of the device of the invention, said at least one organic molecule has a molecular weight of from 100 to 200 g·mol⁻¹.
An organic molecule within the sense of the present invention of which the molecular weight is from 100 to 200 g·mol⁻¹ is considered to be a “small” organic molecule. This class of molecule generally has a solubility in a water devoid of ionic liquid of from 0.2 M to 0.5 M.
In accordance with another embodiment of the device of the invention, said at least one organic molecule has a molecular weight of from 200 to 600 g·mol⁻¹.
The organic molecules of which the molecular weight is from 200 to 600 g·mol⁻¹ are considered within the sense of the invention to be “large” molecules. Their solubility in a water devoid of ionic liquid is generally from 0 M to 0.2 M.
Beyond 600 g·mol-1, the organic molecule induces an excessively high viscosity of the aqueous solution, reducing the conductivity of the solution below the threshold of 40 mS·cm⁻¹ defining an electrolytic solution within the sense of the present invention.
In accordance with one embodiment of the device of the invention, said at least one organic molecule has from 1 to 4 fused aromatic rings, preferably from 1 to 3 fused aromatic rings, more preferably 1 aromatic ring or 3 fused aromatic rings.
Beyond 4 fused aromatic rings, the intermolecular interactions are too strong to allow an ionic liquid added in an at least substantially stoichiometric quantity to solubilise the organic molecule in aqueous solution.
In accordance with an advantageous embodiment of the device of the invention, said at least one organic molecule is selected from the family of quinones, catechols, naphthoquinones, orthonaphthoquinones or anthraquinones.
In accordance with a more advantageous embodiment of the device of the invention, said at least one organic molecule is selected from the family of quinones, catechols, naphthoquinones or orthonaphthoquinones. The organic molecules from these families belong to the category of “small” molecules within the sense of the invention.
In accordance with another more advantageous embodiment of the device of the invention, said at least one organic molecule is selected from the family of anthraquinones.
The molecules from the family of anthraquinones belong to the category of “large” molecules. In accordance with an advantageous embodiment, in the device of the invention said at least one organic molecule is hydroxylated in at least one position.
The inventors have found that, with the presence of a hydroxyl group close to one of the two carbonyl functions, that is to say at the alpha or beta position of one of the two carbonyl functions, the electrochemical reversibility of the molecule is assured. In addition, the presence of a hydroxyl function improves the solubility in water and particularly in basic medium.
In accordance with an advantageous embodiment, in the device of the invention, said at least one organic molecule is hydroxylated in at least one position and has a molecular weight of from 100 to 200 g·mol⁻¹.
In accordance with an advantageous embodiment, in the device of the invention, said at least one organic molecule is hydroxylated in at least one position and has a molecular weight of from 200 to 600 g·mol⁻¹.
In accordance with a preferred embodiment of the device of the invention, said at least one organic molecule is selected from the compounds of formulas (II-a) to (II-i):

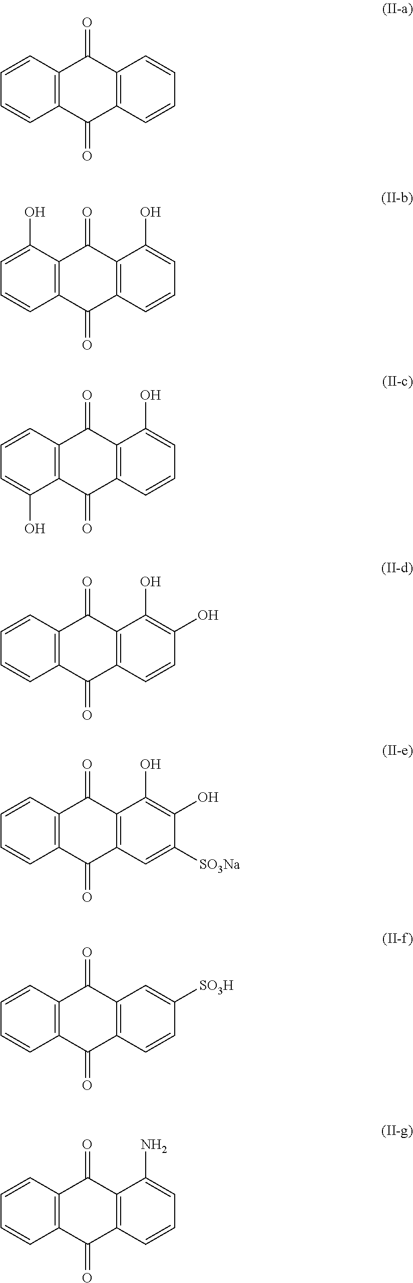

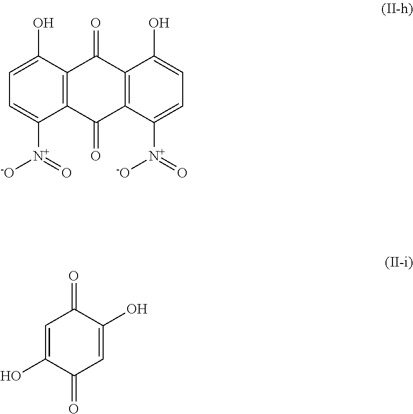

In accordance with one embodiment of the device of the invention, said at least one organic molecule has a solubility in a water devoid of ionic liquid of from 0 M to a value less than 0.1 M.
The organic molecule thus defined is considered to be insoluble in a water devoid of ionic liquid within the sense of the present invention.
The invention is based in particular on the unexpected observation by the inventors of an increase up to 0.1 M of the solubility in a water devoid of ionic liquid of an organic molecule of this kind when 5 equivalents of ionic liquid in relation to the organic molecule are added. Within the sense of the present invention, the expression “solubility in a water devoid of ionic liquid” refers to the solubility of the organic molecule in an aqueous solution as defined in the present invention, in the absence of ionic liquid.
In accordance with another embodiment of the device of the invention, said at least one organic molecule has a solubility in a water devoid of ionic liquid of from 0.1 M to 0.2 M.
The organic molecule thus defined is considered to be poorly soluble in a water devoid of ionic liquid within the sense of the present invention.
The invention is based in particular on the unexpected observation by the inventors of an increase in the solubility of the organic molecule poorly soluble in a water devoid of ionic liquid with addition of a stoichiometric quantity of ionic liquid in relation to the organic molecule.
The addition of the ionic liquid multiplies the solubility of the organic molecule in the aqueous solution by 3 or 5.
In accordance with another embodiment of the device of the invention, said at least one organic molecule has a solubility in a water devoid of ionic liquid of from 0.2 M to 0.5 M.
The organic molecule thus defined is considered to be soluble in a water devoid of ionic liquid within the sense of the present invention.
The invention is based in particular on the unexpected observation by the inventors of an increase in the solubility of the organic molecule soluble in a water devoid of ionic liquid up to a solubility of 1 M by the addition of a stoichiometric quantity of ionic liquid in relation to the organic molecule.
Beyond a solubility of 0.5 M of electroactive organic molecule in a water devoid of ionic liquid, the electrolytic solutions containing an organic molecule of this kind can be used without addition of ionic liquid in a battery.

In accordance with one embodiment, in the device of the invention, said at least one ionic liquid and said at least one organic molecule are present each in a concentration of from 0.1 M to 1 M, preferably from 0.1 M to 0.6 M.

Under these concentration conditions, the ionic liquid is an adjuvant within the sense of the invention and cannot be considered a solvent.
In accordance with one embodiment of the device of the invention, said at least one inorganic salt is an acidic, basic or neutral salt.
In accordance with one embodiment of the device of the invention, said at least one inorganic salt is a strong neutral salt selected from NaCl, KCl, Na₂SO₄, K₂SO₄.
In accordance with another embodiment of the device of the invention, said at least one inorganic salt is a strong acid selected from HCl, H₂SO₄, HClO₄.
The strong acids make it possible to obtain at high concentration, that is to say at a concentration greater than or equal to 1 M, an elevated conductivity of the solution, since the charges (anions and protons) are completely dissociated. Within the sense of the invention, it is possible to define a conductivity as “elevated” if a current of 1 A circulates between the two electrodes of 1 cm² surface and arranged 1 cm away from one another. This value is obtained when the charged particle in solution is the proton, which is the most mobile species of all the ions (before OH⁻).
At a pH lower than or equal to 1, the pH of the electrolytic solution hardly changes, without addition of an additive. Under these conditions, only the ions H⁺ assure the electrical conductivity of the solution, which is then qualified as being elevated.
The solutions of which the pH is greater than 1 and less than or equal to 7 are buffered with the aid of an additive comprising a mixture of a weak acid and its conjugate base, that is to say the pH of the solution will change very little. The mixtures of a weak acid and its conjugate base and the proportions thereof making it possible to obtain buffer solutions of which the pH is between a value greater than 1 and a value less than or equal to 7 are known to a person skilled in the art. For example, the mixture CH₃COOH/CH₃COO⁻,Na⁺ makes it possible to obtain buffer solutions of which the pH is from 3.8 to 5.8. For solutions of which the pH is from 1.9 to 3.9, a mixture of ClCH₂COOH/ClCH₂COO⁻,Na⁺ can be selected. The buffer solution advantageously has a concentration of from 0.1 to 2 M of the mixture of a weak acid and its conjugate base.

In a buffered acidic aqueous solution with the mixture CH₃COOH/CH₃COO⁻,Na⁺ the electrical conductivity is assured by the mobility of the ions present in majority, that is to say CH₃COO⁻ et Na⁺. The ions CH₃COO⁻ and Na⁺ being larger than the proton H⁺ they move more slowly in solution and contribute to a reduction of the electrical conductivity compared to a non-buffered acidic aqueous solution of which the pH is less than or equal to 1.

In order to assure a good ionic conductivity, at least one buffer solution 2 M which frees 1 M of positive and negative charge in solution is required.
Lastly, a conductive buffer solution is very concentrated in various inorganic and organic ions, which hampers the solubility of an organic molecule. In this case, the solution can be buffered for example between 0.1 and 0.5 M, and the conductivity of the medium is increased by the addition of a neutral inorganic salt.
In accordance with another embodiment of the device of the invention, said at least one inorganic salt comprises two inorganic salts.
In accordance with an advantageous embodiment of the device of the invention, with use of at least one ionic liquid, said two inorganic salts are selected from a neutral inorganic salt and an acidic inorganic salt.
In particular, the neutral inorganic salt is selected from NaCl, KCl, Na₂SO₄, K₂SO₄ and the acidic inorganic salt is selected from the strong acids HCl, H₂SO₄, HClO₄.
In accordance with another embodiment of the device of the invention, said at least one inorganic salt is a strong base selected from NaOH, KOH, LiOH.
At a pH greater than or equal to 13, the pH of the electrolytic solution hardly changes, without addition of an additive. Under these conditions, only the ions HO⁻ assure the electrical conductivity of the solution.
The solutions of which the pH is greater than or equal to 7 and less than 13 are buffered with the aid of an additive comprising a mixture of a weak base and its conjugate acid, that is to say the pH of the solution will change very little. The mixtures of a weak base and its conjugate acid and the proportions thereof making it possible to obtain buffer solutions of which the pH is between a value greater than or equal to 7 and less than 13 are known to a person skilled in the art. The buffer also contributes to assuring the conductivity of the electrolytic solution. In this case the electrical conductivity, however, remains reduced compared to the electrical conductivity of a non-buffered basic solution, but can be increased by the addition of a basic inorganic salt. The use of at least one ionic liquid according to the invention thus involves two inorganic salts.
In accordance with an advantageous embodiment of the device of the invention, said two inorganic salts are selected from a neutral inorganic salt and a basic inorganic salt.
In particular, the neutral inorganic salt is selected from NaCl, KCl, Na₂SO₄, K₂SO₄ and the basic inorganic salt is selected from the strong bases NaOH, KOH, LiOH.
In a solution of strong acid or strong base, the addition of a strong neutral salt (completely dissociated) makes it possible to increase the conductivity without increasing the already significant quantity (at least 0.5 mol·L⁻¹) of protons or hydroxides.
In accordance with one embodiment of the device of the invention, said inorganic salt has a concentration of from 0.5 to 3 M, more particularly of from 1 M to 2.5 M, preferably of 2 M. Below 0.5 M, the quantity of ions in the aqueous solution is too low to achieve the conductivity of 40 mS·cm¹ of the electrolytic solution of the invention.
Beyond 3 M of inorganic salts, and depending on their nature, a number of phenomena can appear, since the electrolytic solutions of the invention are highly charged with molecules and ions (organic molecule+ionic liquid+inorganic salts). Thus, 1) the inorganic salt may be at its limit of solubility in the solution in question, 2) the inorganic salt may saturate the solution and its excess may result in the insolubility of the organic molecule, 3) beyond the saturation of the inorganic salt, two liquid phases of different density may appear.

In accordance with one embodiment of the device of the invention, said electrolytic solution has an electrical conductivity a greater than 40 mS·cm¹, in particular greater than 100 mS·cm¹, preferably of from 100 to 200 mS·cm¹.

Below 40 mS·cm¹, the conductivity becomes low, as does also the intensity of the current between two electrodes. Thus, in an electrolysis process, if the current is low, the speed of transformation of a product will be low, and the duration of the electrolysis will be very long. This procedure cannot be applicable to an industrial process.
The same is true for a battery or a cell: if the conductivity is low, the current produced will be low.
Conversely, the higher the conductivity, the greater the efficacy of the electrochemical process is considered to be.
In accordance with one embodiment of the device of the invention, said electrolytic solution has a viscosity of from 1 to 400 cP measured at 20° C. with a shear rate of 25 s⁻¹. 1 centipoise is the viscosity of water.
In accordance with an advantageous embodiment of the device of the invention, said electrolytic solution has a viscosity of from 1 to 125 cP measured at 20° C. with a shear rate of 25 s⁻¹.
Since the solvent used in the present invention is water, the viscosity of the obtained solution cannot be less than 1 cP. The upper limit is fixed at 125 cP, which corresponds to the viscosity of an electrolytic solution tested in battery mode and demonstrating minimal performance levels.
In accordance with another advantageous embodiment of the device of the invention, said electrolytic solution has a viscosity between a value greater than 125 cP to a value of 400 cP, measured at 20° C. with a shear rate of 25 s⁻¹.
Between a value greater than 125 cP and a value of 400 cP, the electrolytic solution belongs to the invention if the electrical conductivity is greater than 45 mS·cm¹ and the solubility of the organic molecule reaches 0.5 M in aqueous solution by the addition of an ionic liquid. This electrolytic solution is used in devices other than batteries, such as cells or in electrolysis devices.
Beyond 400 cP, the electrical conductivity of the solution can no longer reach 45 mS·cm¹. Under these conditions, a spontaneous device such as a cell demonstrates minimal performance levels.
Electrolysis is a non-spontaneous process, the reverse of cells and batteries, the energy cost of which rises increasingly with the increase in viscosity. Thus, beyond 400 cP, the energy cost associated with the execution of an electrolysis operation is too great for industrial application. In accordance with one embodiment of the device of the invention, said electrolytic solution has a half-wave potential of from −1.1 V/SCE to −0.7 V/SCE for a basic solution of which the concentration of hydroxide ions is greater than 0.5 mol·L⁻¹.

The invention also relates to the use of the electrolytic device of the invention to implement a process of electrochemical storage.

In accordance with one embodiment, the use of the electrolytic device of the invention is electrolysis.
“Electrolysis” is a non-spontaneous electrochemical process which induces a chemical transformation by the passing of electrical current through a substance.
In accordance with one embodiment, the use of the electrolytic device of the invention is for the preparation of a battery or a cell.
Within the sense of the present invention, the term “battery” means that two electroactive substances, each soluble in an electrolytic solution, react chemically upon contact with the electrodes to provide electrical energy. The two transformed electroactive substances can be regenerated by electrolysis by reversing the direction of circulation of the solutions.
Within the sense of the present invention, the term “cell” refers to a device in which two electroactive substances, each soluble in an electrolytic solution, react chemically upon contact with the electrodes to provide electrical energy. At least one of the two transformed electroactive substances cannot be regenerated by electrolysis by reversing the direction of circulation of the solutions. The device is irreversible, unlike a battery, which is a reversible device.
Batteries and cells are devices of which the operation is spontaneous, unlike electrolysis devices.
In accordance with one embodiment, the electrolytic device of the invention is used in order to implement a process of electrochemical storage;
in particular said electrochemical storage taking place in a battery or cell, in particular a molecular circulating electrolyte battery, or a molecular circulating electrolyte cell.
   In accordance with one embodiment, in the use of the electrolytic device of the invention said battery is a molecular circulating electrolyte battery.
   The term “molecular battery” means that the chemical reactions are catalysed by organometallic catalysts blocked on at least one electrode. This expression also means that the electroactive substances are organic molecular compounds.
   The term “circulating electrolyte” means that the electrolytic solutions percolate through two porous electrodes. The two solutions are each stored in a reservoir.
   The objective of the use of the electrolytic device of the invention in a circulating electrolyte battery is to increase the storage of energy on account of an improved solubilisation of the active species.
   Indeed, an important role attributable to circulating electrolyte batteries is that of supporting renewable energies (wind and photovoltaic) in order to regulate the consumption of electrical energy. In the presence of wind or the sun, the energy released is used directly, and the excess is stored by a circulating electrolyte battery. If the wind or the brightness are insufficient, it is the battery that assures the production of energy. For example, depending on the volumes of the reservoirs, this system of exchange and regulation is conceivable to assure the energy independence of a house, an eco neighbourhood, a farm, or a factory.
   The principle of a molecular circulating electrolyte battery (FIG. 5) is based on the circulation of an aqueous solution through a porous electrode. The oxidant (Ox1) and the reductant (Red2) in contact with a catalyst immobilised on the electrode bring about the electronic transfers leading to the creation of an electrical current. The advantages of this battery are multiple and lie above all in the fact of using an aqueous solution, providing instantaneous operation as soon as the fluid circulates, providing an electrical capacitor directly connected to the volumes of the storage reservoirs, and working with regenerative solutions.
   The important point resulting from this design is that the quantity of available energy (Joules or watt hours) and the developed power (watts) are optimised independently. In effect:
   The power of the battery is associated with the potential difference between the two redox couples and the surface of the electrodes. The power of the battery is a function of the dimensions and the nature of the electrodes.
   The quantity of energy is associated with the volumes of the reservoirs and the concentration of the redox couples.
      The quantity of electricity stored is therefore associated with the quantity of electroactive organic molecule (example: quinone, anthraquinone, etc.) dissolved in the electrolytic solution. Consequently, the quantity of electricity is proportional to the solubility of the electroactive organic molecule and to the volume of the reservoir in which the molecule is solubilised.

The invention, and also the various advantages presented thereby, will be more easily understood on the basis of the following description of non-limiting embodiments provided with reference to the drawings, in which:

FIG. 1 shows the cyclic volt-amperogram of alizarin RedS A) without addition of ionic liquid and B) with 0.6 M of ionic liquid, obtained with a scanning speed of 100 mV·s⁻¹, the working electrode being a vitreous carbon electrode;

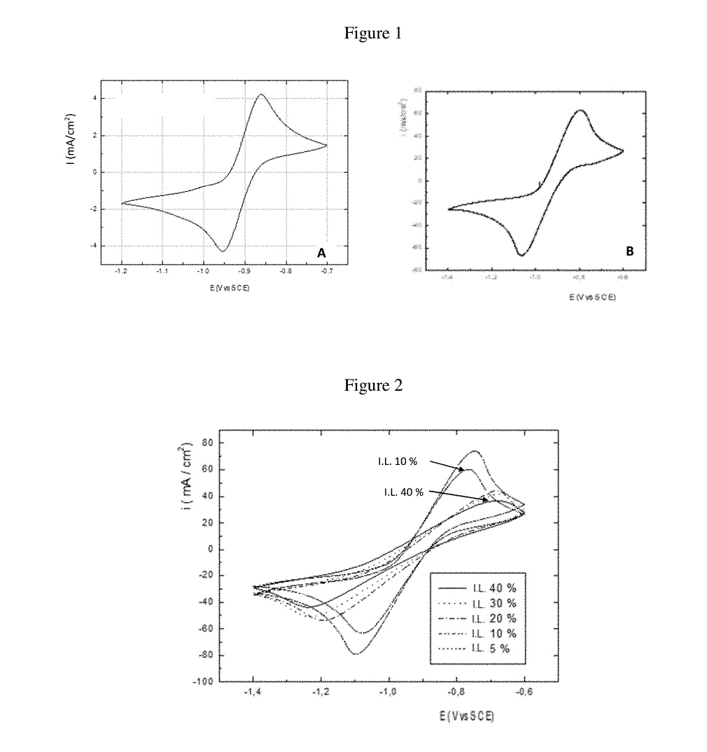

FIG. 2 shows the development of the cyclic volt-amperogram of alizarin RedS at 0.6 M in an aqueous solution at 0.2 M of KOH as a function of the volume of added ionic liquid (electrode=vitreous carbon; scanning speed=100 mV·s⁻¹);

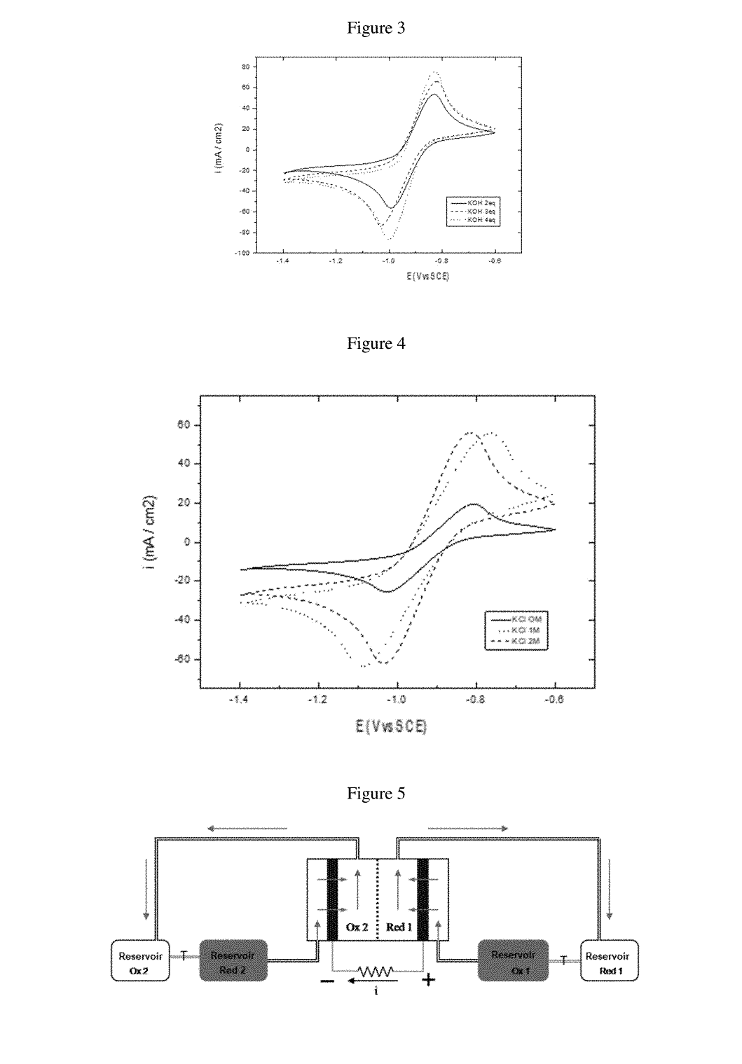

FIG. 3 shows the development of the cyclic volt-amperogram of alizarin RedS at 0.6 M, in the present of 0.6 M of ionic liquid, as a function of the added number of equivalents of KOH. the equivalent corresponds to 0.6 M of KOH (solid line: 2 eq, dashed line: 3 eq, dotted line: 4 eq), (electrode=vitreous carbon; scanning speed=100 mV·s⁻¹);

FIG. 4 shows the development of the cyclic volt-amperogram of alizarin RedS at 0.6 M in an aqueous solution at 0.6 M of KOH as a function of the concentration of KCl (solid line: 0 eq, dashed line: 1 eq, dashed line: 2 eq), (electrode=vitreous carbon; scanning speed=100 mV·s⁻¹);

FIG. 5 shows the operating principle of a molecular circulating electrolyte battery.

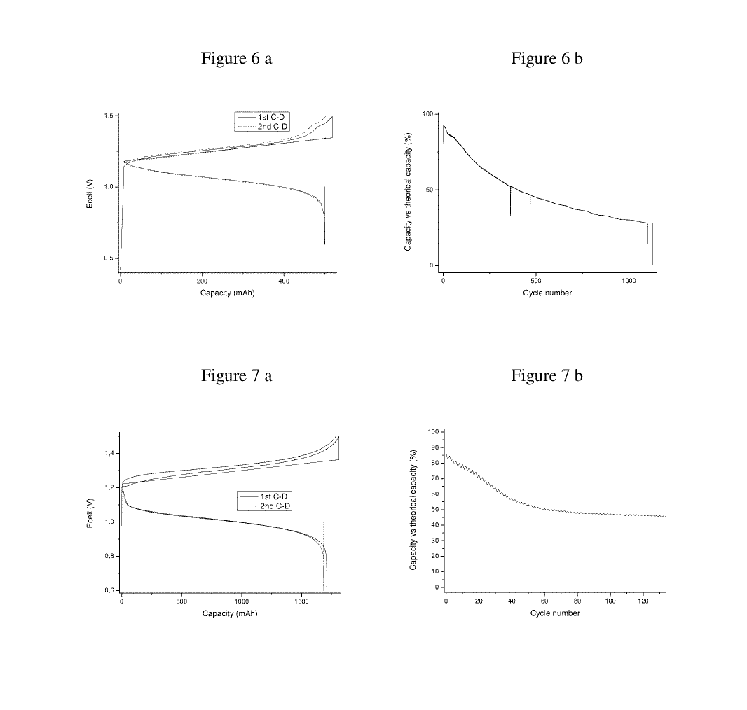

FIG. 6a shows the development of the potential of a battery with 0.1 M alizarin, without ionic liquid, as a function of the capacity over the first two cycles (solid line: first cycle, dotted line: second cycle), FIG. 6b shows the development of the ratio of the capacity to theoretical capacity of the battery as a function of the number of cycles performed.

FIG. 7a shows the development of the potential of a battery with 0.5 M of alizarin and 0.5 M of dimethylimidazolium methylsulfate as ionic liquid, and, as a function of the capacity over the first two cycles (solid line: first cycle, dotted line: second cycle), FIG. 6b shows the development of the ratio of the capacity to theoretical capacity of the battery as a function of the number of cycles performed.

### EXAMPLES

### Synthesis of Ionic Liquids

The ionic liquids were obtained in accordance with the conventional synthesis scheme described numerous times in the literature. In the case of ionic liquids with sulfate anion, the compound used to form the basis of the cation (for example imidazole, amine, etc.) is directly reacted with a dialkylsulfate (Green Chem 2012, 14, 725). In the case of other anions (for example dicyanamide, tetrafluoroborate), the compound used to form the basis of the cation is reacted with an alkyl halide (for example bromobutane) during a phase referred to as quaternisation, then the obtained salt is used in an anionic metathesis with the salt corresponding to the targeted anion (for example sodium tetrafluoroborate) (Green Chem 2005, 7, 39).

Table 1 groups together three ionic liquids used in the present invention.

TABLE 1
Ionic liquids used in the invention

| | |
|---|---|
| 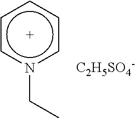 | (I-a) |
| 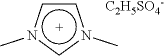 | (I-b) |
| 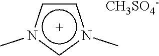 | (I-c) |
| 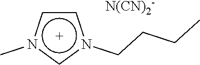 | (I-d) |
| 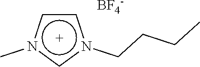 | (I-e) |
| 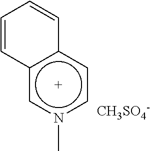 | (I-f) |

### Method of Cyclic Voltammetry

The action of the ionic liquids on the solubility of the organic molecules can be observed by a simple electrochemical analysis. The method used is voltammetry with linear variation of the potential. The result is the plotting of a curve i=f(E) of which the value of the oxidation or reduction current of the electroactive molecule is proportional to its concentration in solution. The electrochemical analyses are performed in an electrochemical cell of which the volume is 40 ml. The volume of the solutions introduced into the electrochemical cell is 10 ml.

In order to perform the analyses, three electrodes immersed in the solution are used:
Working electrode. The working electrode is the location of the studied electrochemical reaction. In this instance, an electrode which is made of vitreous carbon and has a surface of 3 mm diameter, or a nickel electrode of 5 mm diameter was used. The electrochemical reactions are often sensitive to the nature of the electrodes. For example, depending on their nature, some electrodes may passivate and others may not, compared to the same electrochemical system in solution.
Counter electrode. The counter electrode enables the passage of the current in the solution between itself and the working electrode. This electrode must be very stable (for example must not dissolve in the event of oxidation). To maintain stability, the counter electrode is made of platinum (it is a platinum wire of 1 mm diameter).
Reference electrode. This electrode makes it possible to control the potential applied to the working electrode by measuring the difference in potential between itself and the working electrode. The particular feature of a reference electrode is that it has a potential that is fixed. Thus, the potential of the working electrode is referenced relative to the used reference electrode. The reference electrode used in this instance is a saturated calomel electrode of which the potential E°=0.248 V/SHE.

These three electrodes are connected to a potentiostat “SP50” from the company Biologic. The potentiostat is controlled by a computer via the software EClab from the company Biologic.

The electrochemical responses obtained are very similar, regardless of the ionic liquid (I-a), (I-b) or (I-c) used to dissolve an organic molecule. The following examples are applicable to each ionic liquid (I-a), (I-b) and (I-c).

### Protocol for Test of Maximum Solubility of Organic Compounds of Interest in Ionic Liquid/Basic Aqueous Solution Mixtures (Flask Method)

100 mg of the targeted organic compound are introduced into a flask as well as the desired quantity of ionic liquid to be tested. A basic aqueous solution is added in portions of 0.1 mL until a solution is obtained. The maximum concentration is then determined in accordance with the following formula:

Cₘₐₓ=[m_{compound}/M_{compound}]/V

Cₘₐₓ is the maximum concentration of given organic molecule in mol·L⁻¹, m_{compound} is the mass of the introduced organic molecule (in g), M_{compound} is the molar mass of this organic molecule (in g·mol⁻¹) and V is the volume of added aqueous solution (in L).

### Protocol of Solubilisation of Quinone Derivatives in an Ionic Liquid/Basic Aqueous Solution Mixture in the Presence of Hydroxide Ions

The quinone is introduced into a volumetric flask (the quantity is dependent on the targeted concentration, generally between 0.1 and 0.5 M). The liquid is added (the quantity is dependent on the solubilising power of the ionic liquid, in stoichiometric quantity in relation to the quinone). An aqueous solution containing hydroxide ions at a concentration between 0.1 and 5 M is added until the flask is full. The mixture is then placed for 5 minutes in an ultrasonic bath to assure a good dispersion of the compounds. This mixture is then observed under binocular microscope and, if there is doubt as to the solubility (for example in the case of a solution that is too heavily coloured), a filtration under reduced pressure over a PES (polyethersulfone) membrane is performed in order to assure that no particles are in suspension.

### Measurements of the Viscosity of the Solutions

The viscosities of the solutions are measured with the aid of an Anton Paar MCR301 rheometer at a temperature of 20° C. and at a shear rate of 25 s⁻¹.

### Measurements of the Conductivity of the Solutions

The conductivities of the solutions are measured with the aid of a Tucassel CDRV 62 conductometer at a temperature of 20° C.

### Measurements of the Capacity of the Batteries

The capacities of the batteries are measured in a cell of 25 cm². The separator used is a Nafion 117 membrane, the collectors are made of graphite (SGL), and the electrodes are made of graphite (SGL 4.6 mm). The charging and discharging current are fixed at 40 mA/cm².

### Example 1

Alizarin redS is an anthraquinone of which the solubility is approximately 0.2 mol·L⁻¹ in a solution of potassium (KOH) at a concentration of 2 mol·L⁻¹. In the presence of 0.6 M of ionic liquid, the solubility of the alizarin is increased to 0.6 mol·L⁻¹.

The concentration of the ionic liquid is 0.6 mol·L⁻¹, that is to say identical to that of alizarin redS. The increase of the solubility is manifested by a significant increase in the intensity of the oxidation peak and the reduction peak by a factor of 15 (FIG. 1). The intensity obtained is slightly greater than 60 mA·cm⁻², which is very elevated and reflects the very significant quantity of material dissolved in the vicinity of the electrode.

### Example 2

FIG. 2 shows the development of the electrochemical response of alizarin redS as a function of the volume of added ionic liquid. The percentage in volume is calculated in relation to the total volume of the solution. Under these conditions, 10 vol. % represents an addition in stoichiometric quantity with alizarin redS. Within the sense of the invention, alizarin redS is a “large” molecule of poor solubility in a water devoid of ionic liquid.

The electrochemical response drops severely for additions by volume greater than 10%. This phenomenon is associated with an excess of ionic liquid, the consequence of which is a drop in the electrical conductivity of the solution. Beyond the stoichiometric ratio (10 vol. %), the electrical resistance of the solution (ohmic voltage drop) increases very rapidly. Under these conditions, these mixtures become unsuitable for use in an electrochemical process in which strong currents develop. Conversely, for a percentage less than 10%, the electrochemical response is improved. However, the solution rapidly becomes increasingly “pasty” and starts to solidify after a few minutes. The ionic liquid added in a quantity less than 0.8 equivalent of organic molecule is no longer able to fulfil is solubilising role.

### Example 3

Table 2 summarises the results of a series of tests of solubilisation of molecules belonging to the family of anthraquinones.

TABLE 2
Influence of the solubility of the anthraquinones as a function of
the concentration of ionic liquid

| | | Solubility in KOH | |
|---|---|---|---|
| | | 2 mol · L⁻¹ and | |
| | | ionic liquid | |
| | Solubility | Anthra- | Ionic |
| | in KOH | quinone | liquid |
| | 2 mol · | (mol · | (mol · |
| Formulas | L⁻¹ | L⁻¹) | L⁻¹) |
| 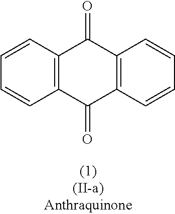 [SMILES: O=C1c2ccccc2C(=O)c2ccccc21] | insoluble | slightly soluble (<10⁻¹) | 0.6 |
| 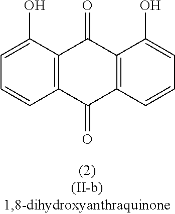 [SMILES: O=C1c2cccc(O)c2C(=O)c2c(O)cccc21] | 0.1 | 0.5 | 0.5 |
| 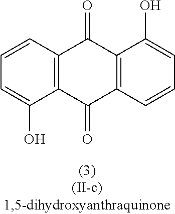 [SMILES: O=C1c2cccc(O)c2C(=O)c2cccc(O)c21] | 0.1 | 0.5 | 0.5 |
| 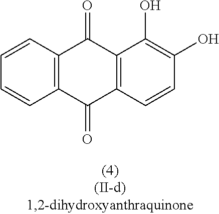 [SMILES: O=C1c2ccccc2C(=O)c2c1ccc(O)c2O] | 0.1 | 0.5 | 0.5 |
| 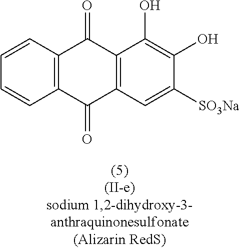 | 0.2 | 0.6 | 0.6 |
| 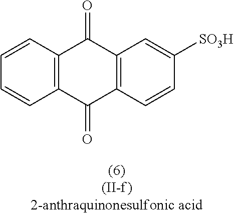 [SMILES: O=C1c2ccccc2C(=O)c2cc(S(=O)(=O)O)ccc21] | <0.1 | 0.1 | 0.5 |
| 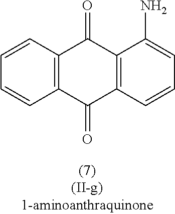 [SMILES: Nc1cccc2c1C(=O)c1ccccc1C2=O] | <0.1 | 0.1 | 0.5 |
| 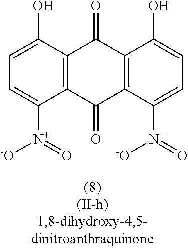 | <0.1 | 0.1 | 0.5 |

In all of the examples, the addition of an ionic liquid of formula (I-a), (I-b) or (I-c) increases the solubility of the anthraquinones. The concentration of ionic liquid at the minimum is equal to the concentration of anthraquinone (case of anthraquinones no. 2, 3, 4 and 5). An excess of ionic liquid is necessary for the anthraquinones of which the natural solubility in a solution of pH=14 is very weak (case of anthraquinones no. 1, 6, 7 and 8).

### Example 4

In KOH 2M, in proportion 1:1 with alizarin, 1,3-dimethylimidazolium methyl sulfate makes it possible to obtain a solution of concentration greater than 0.5M, whereas this is not possible with N-methylisoquinolinium methyl sulfate (a precipitate is still visible at 0.5M). The same is true if the proportion of 1,3-dimethylimidazolium methyl sulfate in relation to alizarin is less than 1:1, a precipitate is still visible at 0.5M. If a mixture of these two ionic liquids in the following proportions: alizarin/1,3-dimethylimidazolium methyl sulfate/N-methylisoquinolinium methyl sulfate 1:0.5:0.5 is used, a solution of concentration 0.8M is obtained, whereas the two isolated ionic liquids used in the same proportions (alizarin/ionic liquid 1:0.5) do not make it possible to obtain a solution at 0.5M. This observation is repeated with an alizarin/N,N-diisopropylethylmethylammonium methyl sulfate/N-methylisoquinolinium methyl sulfate 1:0.5:0.5.

### Example 5

FIG. 3 is a study of the electrochemical response of alizarin red S (anthraquinone no. 5) as a function of the concentration of KOH. The hydroxide ions (OH⁻) are involved in the autoprotonation balance of water, which is the primary solvent of the electrolytic solution. Taking into consideration the concentrations of hydroxides (OH⁻), these influence the pH of the solution, which is approximately 14, is difficult to calculate and is difficult to measure.

The concentration of ionic liquid of formula (I-a) is 0.6 mol·L⁻¹ for a concentration of alizarin red S of 0.6 mol·L⁻¹. A strong addition of KOH does not interfere with the principle of solubilisation with the aid of the ionic liquids and significantly increases the electrochemical response.

This result is important because the technique of solubilisation by ionic liquids can be implemented in solutions of which the ionic force reaches values outside the norm, which is entirely favourable for their use as electrolytic solution.

Assuming that the ions are free among themselves, table 3 summarises the values for the ionic force (I) as a function of the concentration of KOH.

TABLE 3
Development of the ionic force as a function
of the concentration of KOH.

| | | | |
|---|---|---|---|
| [KOH] (mol · L⁻¹) | 1.2 | 1.8 | 2.4 |
| Ionic force = I | 1.2 | 1.5 | 1.8 |

I=½ΣCᵢzᵢ²
with Cᵢ=concentration of the ion i
Zᵢ=valence of the ion i
and: [I.L.]=0.6 mol·L⁻¹; [A redS⁻, Na⁺]=0.6 mol·L⁻¹

The ions present in the solution are monovalent; consequently, the ionic force also reflects the molar concentration of positive and negative charges. For concentrations of this kind, the ionic conductivity of each solution largely supports the intensities of 1 A applied between two electrodes spaced apart from one another by 1 cm.

Lastly, an increase in the electrical activity of the solution associated with an increase in the concentration of the ions (OH⁻) originating from the autoprotolysis balance of water (solvent) exacerbates the electrochemical response of alizarin redS (FIG. 3). It is important to note also that, even in the presence of an excess of KOH (quantity greater than 2 equivalents), the solubility afforded by the ionic liquid/organic molecule interaction is not influenced.

### Example 6

In this example the electrochemical response of alizarin redS is studied as a function of the concentration of KCl. The concentrations of alizarin redS, of KOH, and of the ionic liquid are identical and fixed at 0.6 mol·L⁻¹. Table 4 shows the value of the ionic force for different concentrations of KCl.

TABLE 4
Development of the ionic force as a function
of the concentration of KCl.

| | | | |
|---|---|---|---|
| [KCl] (mol · L⁻¹) | 0 | 1 | 2 |
| Ionic force = 1 | 0.6 | 1.1 | 1.6 |

A strong addition of KCl does not interfere with the principle of solubilisation with the aid of the ionic liquids. The electrochemical response (FIG. 4) is increased significantly up to an ionic force of approximately 1 in order to stabilise beyond this value.

This example shows that, for a fixed pH, a solution comprising a molecule solubilised by the technique of using ionic liquids can demonstrate an electrochemical response that is variable as a function of the addition of a neutral salt. This phenomenon confirms that the interactions between the ionic liquid and the anthraquinone are effective.

This solubilisation technique makes it possible to work with solutions concentrated with ions, which makes it possible, whilst keeping the solubility constant, to increase the electrical conductivity of the solution by the addition of a neutral conductive salt, such as KCl, NaCl, NaBF₄, Na₂SO₄, K₂SO₄, etc.

### Example 7

TABLE 5
Measurements of the half-wave potential, conductivity, and
viscosity of various electrolytic solutions.

| Reference | E ^{1/2} | Conductivity | Viscosity |
|---|---|---|---|
| solution | (V vs SCE) | (mS · cm⁻¹) | (cP) |
| 1 | −0.94 | 49 | 1.85 |
| 2 | −0.92 | 60 | 53.6 |
| 3 | −0.89 | 40 | 112.3 |
| 4 | −0.88 | 47 | 393.6 |
| 5 | −0.89 | 46 | 17.9 |
| 6 | −0.88 | 97 | 122.1 |
| 7 | −0.87 | 64 | 4.21 |
| 8 | −0.87 | 63 | 4.51 |

Compositions of the solutions:

### Solution 1: 2,5-dihydroxy-1,4-benzoquinone (II-i) 0.83M; 1,3-dimethylimidazolium Methyl Sulfate (I-c) 0.83M; KOH 2M

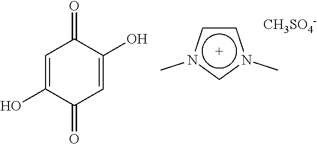

### Solution 2: Alizarin (II-d) 0.5M; 1,3-dimethylimidazolium Methyl Sulfate (I-c) 0.5M; KOH 2M

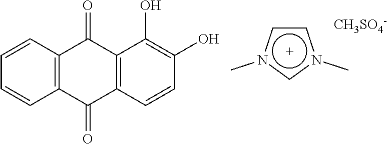

### Solution 3: Alizarin Red S (II-e) 0.6M; 1,3-dimethylimidazolium Methyl Sulfate (I-c) 0.6M; KOH 2M

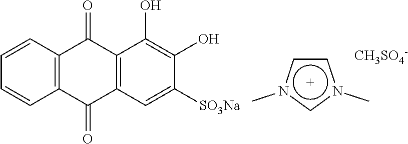

### Solution 4: Alizarin (II-d) 0.5M; 1,3-dimethylimidazolium Methyl Sulfate (I-c) 0.25M; N-methylisoquinolinium Methyl Sulfate (I-f) 0.25M; KOH 2M

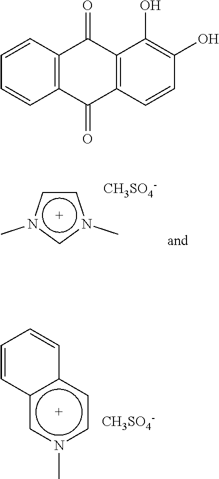

### Solution 5: Alizarin (II-d) 0.5M; N,N-diisopropylethylmethylammonium Methyl Sulfate (I-g) 0.5M; KOH 2M

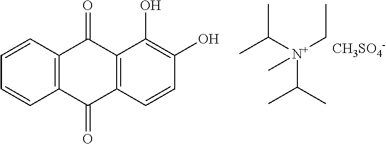

### Solution 6: Alizarin (II-d) 0.5M; 1,3-dimethylimidazolium Methyl Sulfate (I-c) 0.5M; KOH 3M

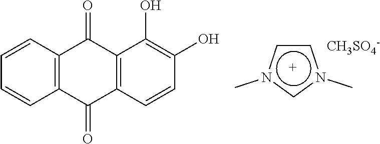

### Solution 7: Alizarin (II-d) 0.5M; 1-methyl-3-butylimidazolium dicyanamide (I-d) 0.5M; KOH 2M

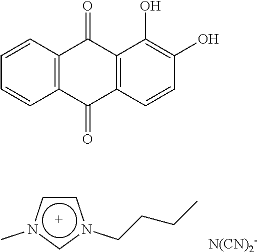

### Solution 8: Alizarin (II-d) 0.5M; 1-methyl-3-butylimidazolium tetrafluoroborate (I-e) 0.5M; KOH 2M

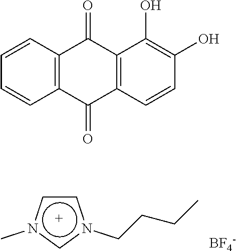

Solution 4 is an example of an ionic liquid mixture illustrating the modulation of the properties of the electrolytic solution as a function of the ionic liquids. By comparison with solution 2 (same organic molecule; one ionic liquid in common), the aqueous solubility of the organic molecule is identical, however the conductivity of solution 4 is reduced and its viscosity is largely increased. This example shows that the nature of the ionic liquid (besides the effect of solubilisation) significantly influences the viscosity of the medium.

Solution 5 is an example of the use of an ionic liquid comprising an aliphatic cation.

Compared to solution 2, solution 6 comprises the same constituents, but has an increase in inorganic salt, KOH. This solution presents an increase in the conductivity, but a decrease in the viscosity. Depending on the use of the targeted solution, a compromise is thus generally necessary between elevated conductivity (greater than 50 mS·cm¹) and low viscosity (less than 125 cP).

Compared to solution 2, solution 7 corresponds to a modification of the anion of the ionic liquid which makes it possible to decrease the viscosity of the solution by a factor of 10. Thus, the conductivity can be increased with an increase in the concentration of ion OH⁻ without any effect on the viscosity. Solution 8 shows the same phenomenon.

### Example 8

In FIGS. 6a and b, alizarin is introduced without ionic liquid. The electrolytes are prepared as follows: the anolyte is composed of 0.1M alizarin (saturation) in an aqueous solution of KOH 2M; the catholyte is composed of 0.2M of potassium ferrocyanide in an aqueous solution of NaOH 0.5M. The theoretical capacity is 536 mAh.

93 and 97% of the theoretical capacity are achieved during the first two cycles and the RTEs are 97 and 99% (see FIG. 6 a). 565 cycles were performed. The capacity did not stabilise, and dropped to 30% (see FIG. 6 b). The initial power is 130 mW/cm² with a resistance of 2.5Ω.

In FIGS. 7 a and b, alizarin is mixed with dimethylimidazolium methyl sulfate. The electrolytes are prepared as follows: the anolyte is composed of 0.5M alizarin and 0.5M dimethylimidazolium methyl sulfate in an aqueous solution of KOH 2M; the catholyte is composed of 0.6M of potassium ferrocyanide in an aqueous solution of NaOH 0.5M. The theoretical capacity is 1600 mAh.

100% of the theoretical capacity is achieved during the first two cycles and the RTEs are 95% (see FIG. 7 a). 130 cycles were performed. The capacity stabilised at 755 mAh (47% of the theoretical capacity, see FIG. 7 b). The initial power is 62 mW/cm² with a resistance of 6.4Ω.

The increase on concentration on account of the addition of the ionic liquid makes it possible to increase the capacity (five times greater with equal volume).

The alizarin is mixed with diisopropylethylmethylammonium methylsulfate. The electrolytes are prepared as follows: the anolyte is composed of 0.3M alizarin and 0.3M diisopropylethylmethylammonium methyl sulfate in an aqueous solution of KOH 2M; the catholyte is composed of 0.56M of potassium ferrocyanide in an aqueous solution of NaOH 0.55M/KOH 0.3M. The theoretical capacity is 798 mAh.

92% and 90% of the theoretical capacity are achieved during the first two cycles and the RTEs are 89%. 37 cycles were performed and the capacity stabilised at 40% of the theoretical capacity. The initial power is 59 mW/cm² with a resistance of 2.1Ω.

The increase in concentration on account of the addition of the ionic liquid makes it possible to increase the capacity (three times greater with equal volume).

1. Method to increase the solubility of at least one organic molecule in aqueous solution containing at least one inorganic salt and to obtain an electrolytic solution, wherein said aqueous solution comprises at least one ionic liquid, wherein said at least one ionic liquid and said at least one organic molecule are present in said aqueous solution in at least substantially stoichiometric quantities.

2. Method according to claim 1, wherein said at least one ionic liquid comprises a hydrophilic anion and an aromatic heterocyclic cation or an aliphatic cation; or
wherein said hydrophilic anion is selected from the methane sulfate, ethane sulfate, chloride, iodide, tetrafluoroborate, thiocyanate, dicyanamide, trifluoroacetate, nitrate or hexafluorophosphate anion, preferably selected from the methane sulfate, ethane sulfate, tetrafluoroborate or dicyanamide anion; or
wherein said aromatic heterocyclic cation being selected from an imidazolium, a pyridinium or a quinolinium; or wherein said aliphatic cation is selected from an ammonium.

3. Method according to claim 1, wherein said at least one ionic liquid is present in a volume percentage of from 5 to 20% in relation to the total volume of the solution.

4. Method according to claim 1,
wherein said at least one organic molecule is polar or apolar; and/or
wherein said at least one organic molecule is electroactive; and/or
wherein said at least one organic molecule has a molecular weight of from 100 to 600 g·mol⁻¹, or of from 100 to 200 g·mol⁻¹, or of from 200 to 600 g·mol⁻¹; and/or
wherein said at least one organic molecule has from 1 to 4 fused aromatic rings, or from 1 to 3 fused aromatic rings, or 1 aromatic ring or 3 fused aromatic rings; and/or
wherein said at least one organic molecule is hydroxylated in at least one position; or
wherein said at least one organic molecule is selected from the family of quinones, catechols, naphthoquinones, orthonaphthoquinones or anthraquinones, or is selected from the compounds of formulas (II-a) to (II-i):

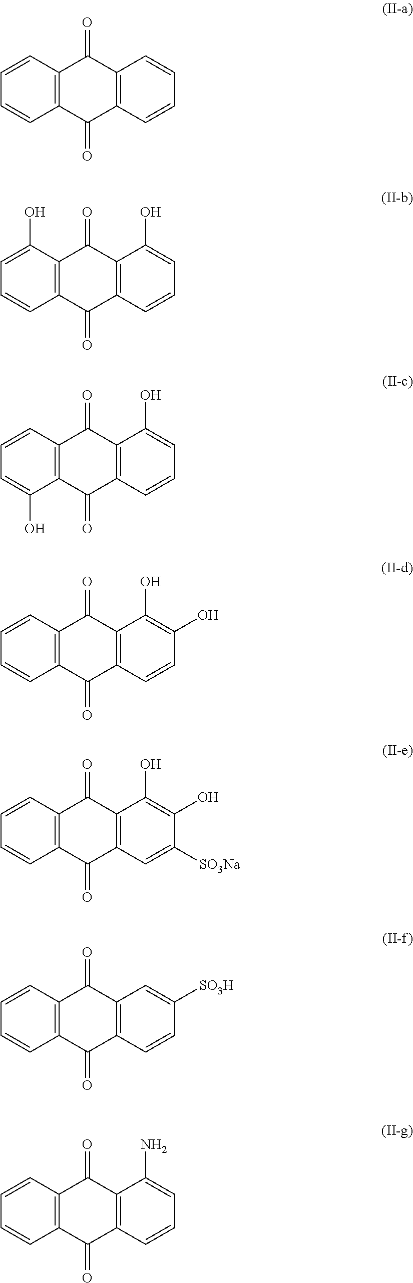

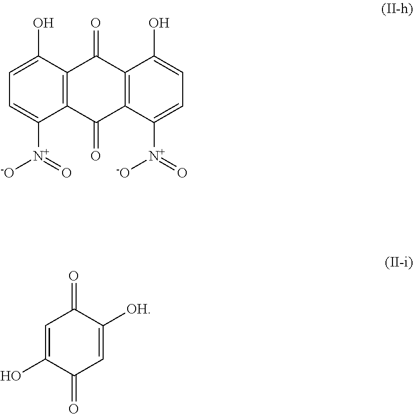

5. Method according to claim 1,
wherein said at least one organic molecule has a solubility in a water devoid of ionic liquid of from 0 M and a value less than 0.1 M.

6. Method according to claim 1,
wherein said at least one inorganic salt is an acidic, basic or neutral salt; or
wherein said at least one inorganic salt is a strong neutral salt selected from NaCl, KCl, Na₂SO₄, K₂SO₄; or
wherein said at least one inorganic salt is a strong acidic salt selected from HCl, H₂SO₄, HClO₄; or
wherein said at least one inorganic salt comprises two inorganic salts, selected from a neutral inorganic salt and an acidic inorganic salt, wherein the neutral inorganic salt is selected from NaCl, KCl, Na₂SO₄, K₂SO₄ and the acidic inorganic salt is selected from the strong acids HCl, H₂SO₄, HClO₄; or
wherein said at least one inorganic salt is a strong base selected from NaOH, KOH, LiOH; or
wherein said at least one inorganic salt comprises two inorganic salts, selected from a neutral inorganic salt and a basic inorganic salt, wherein the neutral inorganic salt is selected from NaCl, KCl, Na₂SO₄, K₂SO₄ and the basic inorganic salt is selected from the strong bases NaOH, KOH, LiOH; or
wherein said inorganic salt has a concentration of from 0.5 to 3 M, or from 1 M to 2.5 M, or of 2 M.

7. Method according to claim 1,
wherein said electrolytic solution has an electrical conductivity a greater than 40 mS·cm⁻¹; and/or
wherein said electrolytic solution has a viscosity of from 1 to 400 cP measured at 20° C. with a shear rate of 25 s⁻¹; and/or
wherein said electrolytic solution has a half-wave potential of from −1.1 V/SCE to −0.7 V/SCE for a basic solution of which the concentration of hydroxide ions is greater than 0.5 mol·L⁻¹.

8. (canceled)

9. (canceled)

10. An electrolytic device comprising the electrolytic solution obtained according to claim 1, comprising at least one ionic liquid, at least one organic molecule, at least one inorganic salt, an aqueous solution, and at least one electrode, said at least one ionic liquid and said at least one organic molecule being present in at least substantially stoichiometric quantities.

11. (canceled)

12. Method according to claim 1, wherein said at least one ionic liquid is selected from the pyridinium ethane sulfate of formula (I-a), the imidazolium ethane sulfate of formula (I-b), the imidazolium methane sulfate of formula (I-c), the imidazolium dicyanamide of formula (I-d), the imidazolium tetrafluoroborate of formula (I-e), the quinolinium methane sulfate of formula (I-f), or the ammonium methane sulfate of formula (I-g):

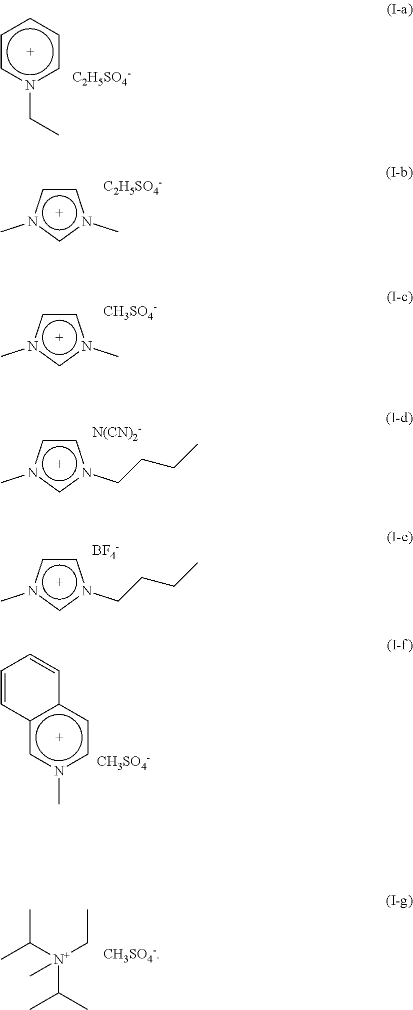

13. Method according to claim 3, wherein said at least one ionic liquid is present in a volume percentage of from 10 to 20% in relation to the total volume of the solution.

14. Method according to claim 5, wherein said at least one organic molecule has a solubility in a water devoid of ionic liquid of from 0.1 M to 0.2 M.

15. Method according to claim 14, wherein said at least one organic molecule has a solubility in a water devoid of ionic liquid of from 0.2 M to 0.5 M.

16. Method of carrying out a process of electrochemical storage utilizing an electrolytic device comprising an electrolytic solution comprising at least one ionic liquid, at least one organic molecule, at least one inorganic salt, an aqueous solution, and at least one electrode, said at least one ionic liquid and said at least one organic molecule being present in at least substantially stoichiometric quantities.

17. Method of carrying out a process of electrochemical storage according to claim 13 wherein said electrochemical storage takes place in a battery or cell, more particularly in a molecular circulating electrolyte battery, or a molecular circulating electrolyte cell.
